(19) United States
(12) Patent Application Publication
(10) Pub. No.: US 2024/0166492 A1
(43) Pub. Date: May 23, 2024

(54) SYSTEMS AND METHODS FOR A MOBILE PRODUCTIVITY PLATFORM

(71) Applicant: MARATHON PETROLEUM COMPANY LP, Findlay, OH (US)

(72) Inventor: Zachary D. Thobe, Findlay, OH (US)

(21) Appl. No.: 18/516,412

(22) Filed: Nov. 21, 2023

Related U.S. Application Data
(60) Provisional application No. 63/384,663, filed on Nov. 22, 2022.

(51) Int. Cl. B67D 3/00; B67D 7/04

(52) U.S. Cl. CPC B67D 3/0058; B67D 7/04

(57) ABSTRACT

System and methods to provide a determined amount of fuel for a vehicle and a determined amount of captured exhaust to offload from a vehicle are disclosed. In embodiments, the system may comprise a bay. The bay may include a fuel dispenser, an exhaust receiver, and a detector configured to (a) determine if the vehicle is approaching the bay and (b) obtain data associated with the vehicle and data associated with a user of the vehicle. The system may include a computing device or controller, in signal communication with the detector, configured to receive the data associated with the vehicle and user, determine a predicted amount of fuel to pump to the vehicle and a predicted amount of exhaust to offload from the vehicle based on the data, and initiating one or more of (a) a fueling operation or (b) an exhaust offloading operation.

### CROSS REFERENCE TO RELATED APPLICATIONS

This application claims priority to, and the benefit of U.S. Provisional Application No. 63/384,663, filed Nov. 22, 2022, titled “SYSTEMS AND METHODS FOR A MOBILE PRODUCTIVITY PLATFORM,” the disclosure of which is incorporated herein by reference in its entirety.

### FIELD OF DISCLOSURE

Embodiments of this disclosure relate to systems and methods for a mobile productivity platform, and more particularly, to systems and methods that predict a consumer's order and allow the consumer to order products and services (such as, fuel via a fueling operation, offloading exhaust, ordering goods and/or services, and/or other services or operations) based on various factors (such as, fuel tank levels, exhaust tank levels, vehicle history, order history, and/or other factors related to a driver and/or vehicle).

### BACKGROUND

Currently, fueling a transportation vehicle is a manual operation. A consumer may drive to a consumer store, park the transportation vehicle in front a fuel pump, exit the transportation vehicle, purchase an amount of fuel using a terminal on the fuel pump, and then pump fuel to the transportation vehicle. If the consumer utilizes cash, as opposed to a debit or credit card, the user then has to estimate the amount of fuel to pump to the transportation vehicle and pay for that amount in the consumer store. Further, rewards systems for such transactions are typically facilitated via sign in, for example, such as using an email or username, or via some other physical identification.

Other types of purchases for example, for goods and/or services) are typically performed or transacted in the consumer store, or via a drive through as well, causing a consumer to potentially wait for an extended period of time in line, looking for a particular product (for example, goods and/or services), and/or wait while processing a payment or transaction via physical money or credit/debit card.

### SUMMARY

Accordingly, Applicant has recognized a need for a mobile productivity platform, and more particularly, to systems and methods that predict a consumer's order and allow the consumer to order products and services (for example, fuel via a fueling operation, offloading exhaust, ordering goods and/or services, and/or other operations or services) based on various factors (for example, fuel tank levels, exhaust tank levels, vehicle history, order history, and/or other factors related to a driver and/or vehicle). The present disclosure is directed to embodiments of such systems and methods.

The present disclosure is generally directed to a mobile productivity platform, and more particularly, to systems and methods that predict a consumer's order and allow the consumer to order products and services (for example, fuel via a fueling operation, offloading exhaust, ordering goods and/or services, and/or other operations or services) based on various factors (for example, fuel tank levels, exhaust tank levels, vehicle history, order history, and/or other factors related to a driver and/or vehicle). Such a mobile productivity platform may comprise or include a computing device, controller, and/or an application on a user device. The application may include a user interface. The computing device may include instructions to detect and connect to an approaching transportation vehicle and/or the application via a detector or sensor at a convenience store, a gas or fueling station, a service station, a restaurant, or other location providing goods and services. In a particular embodiment, and as noted, the detector or sensor may be positioned at the convenience store and gas or fueling station. The detector may be configured to detect a transportation vehicle, the user device, and/or other computing device associated with the user. The detector may, in an embodiment, discover, detect, or determine a position of (for example, in relation to a fueling site or other location) the transportation vehicle, the user device, and/or other computing device associated with the user. The detector may, in response to detection, discovery, and/or determination of a particular position of the transportation vehicle, obtain data related to the user, the user device, the other computing device associated with the user, the transportation vehicle corresponding to or associated with the user, and/or from data storage (the data, for example, including data associated with signals, devices, and/or characteristics of the user and/or transportation vehicle stored in data storage). Once the detector has obtained the data, a computing device or controller (also referred to as a mobile productivity platform computing device or mobile productivity platform controller), in signal communication with the detector, may, using data received from the detector (or the user and/or transportation vehicle), determine a predicted amount of fuel to pump to the transportation vehicle, a predicted amount of exhaust to offload from the transportation vehicle, and/or a predicted good and/or service to purchase, among other predictions.

The predictions described may be based on various factors, the factors being included in the data obtained by the detector. The factors may include one or more of fuel tank level, exhaust tank level, current mileage, previous mileage at last time of fueling and/or exhaust offload, fueling history, exhaust offloading history, transportation vehicle diagnostics and/or status, and/or order/fueling/offloading history, among other factors. In an embodiment, the data obtained by the detector may be encrypted. Various encryption/decryption algorithms (for example, Rivest-Shamir-Adleman (RSA), Diffie-Hellman exchange, and/or other algorithms as will be understood by one skilled in the art) may be utilized to transfer data to/from the vehicle from/to the detector.

The detector may be included in or may be a computing device or controller. The computing device or controller may be configured to determine and/or predict an amount of fuel to pump to the transportation vehicle, an amount of exhaust to offload from the transportation vehicle, and/or another transaction to initiate (for example, transactions such ordering food, beverages, goods, and/or services). For example, the computing device or controller may determine and/or predict the amount of fuel to pump to the transportation vehicle based on fueling history, the previous mileage and current mileage, and/or the fueling tank level. Similarly, the amount of exhaust to offload and/or other transactions may be determined and/or predicted. After a determination and/or prediction, the computing device or controller may initiate operations associated with the determinations and/or predictions. In an example, the computing device or controller may initiate the operation by transmitting a message to a user to accept or adjust such an amount (for example, an amount of fuel and/or exhaust) and, via user interaction, cause the operation to occur. In another embodiment, the computing device or controller may initiate and control the operation for the duration of the operation. In yet another embodiment, such an operation may include physical interaction from the user (for example, placing a nozzle in the user's vehicle for fueling and/or offloading exhaust) or may be automated and controlled by the computing device or controller (for example, via a combination of algorithms and automated or robotic elements).

Accordingly, an embodiment of the disclosure is directed to a system to provide a determined amount of fuel for a vehicle and a determined amount of captured exhaust to offload from a vehicle. The system may include a bay. The bay may include a fuel pump (also referred to as a fuel dispenser), an exhaust pump (also referred to as an exhaust receiver), and a detector. The detector may be configured to (1) discover, detect, or determine if a vehicle is approaching the bay and (2) in response to discovery, detection, or a determination that the vehicle is approaching the bay, obtain data associated with the vehicle and data associated with a user of the vehicle. The system may include a computing device or controller in signal communication with the detector. The computing device or controller may be configured to receive the data associated with the vehicle and data associated with the user of the vehicle from the detector. The computing device or controller may be configured to determine a predicted amount of fuel to pump to the vehicle based on the data associated with the vehicle and data associated with the user of the vehicle from the detector. The computing device or controller may be configured to determine a predicted amount of exhaust to offload from the vehicle based on the data associated with the vehicle and data associated with the user of the vehicle from the detector. The computing device or controller may be configured to, in response to a selection of one or more of an amount of fuel based on the predicted amount of fuel and an amount of exhaust based on the predicted amount of exhaust, initiate one or more of (1) a fueling operation for the amount of fuel via the fuel pump or (2) an exhaust offloading operation for the amount of exhaust via the exhaust pump.

In an embodiment, the one or more of the fueling operation or exhaust offloading operation may occur automatically, via user intervention, or via an attendant's intervention. The detector may be configured to (1) determine whether one or more of a Wi-Fi signal, a RFID signal, a NFC signal, a cellular signal, a Bluetooth signal, or other signal emanates from the vehicle and (2) obtain data therefrom. The detector may further include or comprise one or more of an image capture device configured to capture an image of a specified portion of the vehicle or a geolocation device to obtain coordinates associated with a location of the vehicle.

In another embodiment, the computing device or controller may be in signal communication with a device corresponding to the user and may further be configured to generate a display for a user interface of the device including a selectable and adjustable amount of fuel based on the predicted amount of fuel and a selectable and adjustable amount of exhaust based on the predicted amount of exhaust. The selection of one or more of the amount of fuel or the amount of exhaust may be based on selections via the display. The data associated with the vehicle may include one or more of a fuel tank total capacity, a fuel tank level, exhaust tank total capacity, exhaust tank level, miles per gallon or fuel efficiency, exhaust emitted per gallon, mileage of the vehicle, diagnostic data, or data related to other aspects and/or characteristics of the vehicle. The data associated with the user of the vehicle may include fuel transaction history, exhaust transaction history, a last station visited, transaction data related to the last station visited, or account information and wherein the data associated with the vehicle further includes mileage of the vehicle at the last station visited.

In an embodiment, the computing device or controller may be configured to determine the predicted amount of fuel based on one or more of (1) the fuel tank level; (2) the fuel tank total capacity, miles per gallon or fuel efficiency, mileage of the vehicle, and mileage of the vehicle at the last station visited; (3) fuel transaction history; or (4) a combination thereof. The computing device or controller may be configured to determine the predicted amount of fuel based on one or more of (1) the exhaust tank level; (2) the exhaust tank total capacity, exhaust emitted per gallon, mileage of the vehicle, and mileage of the vehicle at the last station visited; (3) exhaust transaction history; or (4) a combination thereof. The computing device or controller may further be configured to prompt the user to select to finalize transaction on the device and transact payment using data transmitted by the device based on an actual amount of fuel pumped and an actual amount of exhaust offloaded. The computing device or controller may be configured to provide suggestions relating to services associated with the vehicle based on the data associated with the vehicle and data associated with the user of the vehicle. In another embodiment, the computing device or controller may determine types of services for the vehicle based on the data associated with the vehicle and data associated with the user of the vehicle and transmit the types of services for the vehicle to the device. The device may include one or more of a user device, a smart phone, a tablet, a vehicle user interface, or some combination thereof.

In an embodiment, the exhaust pump may be configured to analyze offloaded exhaust. The computing device or controller may be configured to provide suggestions relating to services associated with the vehicle based on based on analyzed offloaded exhaust. In another embodiment, the computing device or controller may determine types of services for the vehicle based on analyzed offloaded exhaust and transmit the types of services for the vehicle to the device. The bay may further comprise a canopy. The detector may be positioned on the canopy and/or comprised of one or more detection devices. Further, the other of the one or more detection devices may additionally be positioned on one or more of the fuel pump, the exhaust pump, proximate to the bay, or at a specified distance from the bay.

Another embodiment of the disclosure is directed to a system to provide a determined amount of fuel for a vehicle and a determined amount of captured exhaust to offload from a vehicle. The system may include a bay. The bay may include a fuel pump, an exhaust pump, and a detector. The detector may be configured to (1) determine if the vehicle is approaching the bay and (2) in response to determination that the vehicle is approaching the bat, obtain data associated with the vehicle and data associated with a user of the vehicle. The system may include a computing device or controller in signal communication with the detector. The computing device or controller may be configured to receive the data associated with the vehicle and data associated with the user of the vehicle from the detector. The computing device or controller may also be configured to prompt the user to select an amount of fuel, from an initial amount of fuel based on one or more of the data associated with the vehicle or data associated with the user of the vehicle from the detector, for the vehicle and to select an amount of exhaust, from an initial amount of exhaust based on one or more of the data associated with the vehicle or data associated with the user of the vehicle from the detector, to offload from the vehicle. The computing device or controller may be configured to, in response to a selection of one or more of the amount of fuel or the amount of exhaust, initiating one or more, initiate one or more of (1) a fueling operation for the amount of fuel via the fuel pump or (2) an exhaust offloading operation for the amount of exhaust via the exhaust pump.

In an embodiment, one or more of the computing device or controller, the vehicle, a user device, the fuel pump, the exhaust pump, or the detector are configured to determine the initial amount of fuel and the initial amount of exhaust based on one or more of the data associated with the vehicle or data associated with the user of the vehicle. The bay may further include the computing device or controller and the computing device or controller may include the detector.

Another embodiment of the disclosure is directed to a method to provide a determined amount of fuel for a vehicle and a determined amount of captured exhaust to offload from a vehicle. The method may include discovering or determining, via a detector of a fuel and exhaust pump computing device or controller positioned proximate to one or more or fuel pumps or exhaust pumps, an aspect, characteristic, and/or a position of a vehicle. The method may include, in response to an indication based on a signal from the detector that the vehicle is positioned adjacent to one or more of the fuel pumps or exhaust pumps, (a) establishing a secure communication channel between the fuel and exhaust pump computing device or controller and the vehicle, (b) obtaining, by the detector via the secure communication channel, one or more of fuel tank characteristics or exhaust tank characteristics, (c) determining one or more of an amount of fuel to fill the fuel tank or an amount of exhaust to empty the exhaust tank based on one or more of the fuel tank characteristics or exhaust tank characteristics, (d) prompting, by the fuel and exhaust pump computing device or controller, one of the one or more vehicles to accept, adjust, or deny (1) the amount of fuel to fill the fuel tank or (2) the amount of exhaust to empty the exhaust tank, and (e) in response to selection by the one of the one or more vehicles (1) to accept an amount of fuel or (2) to offload an amount of exhaust, initiating one or more corresponding fueling operations or exhaust offloading operations.

In an embodiment, the fuel tank characteristics may include a fuel tank level and the exhaust tank characteristics include an exhaust tank level. The corresponding fuel operation may include pumping the amount of fuel to the vehicle, and the corresponding exhaust offloading operation may include pumping the amount of exhaust captured by an onboard capture device of the one of the one or more vehicles.

Another embodiment of the disclosure is directed to a method to provide a determined amount of fuel for a vehicle and a determined amount of captured exhaust to offload from a vehicle. The method may include discovering, detect, or determine, via a detector of a fuel and exhaust pump computing device or controller positioned in each one of one or more or fuel pumps or exhaust pumps, an aspect, characteristic, and/or position of a vehicle. The method may include, in response to an indication based on a signal from the detector that the vehicle is positioned adjacent to a corresponding one of the one or more fuel pumps or exhaust pumps, (a) establishing a secure communication channel between the fuel and exhaust pump computing device or controller and the vehicle, (b) obtaining, by the detector via the secure communication channel, one or more of fuel tank characteristics or exhaust tank characteristics, (c) determining one or more of an amount of fuel to fill the fuel tank or an amount of exhaust to empty the exhaust tank based on one or more of the fuel tank characteristics or exhaust tank characteristics, (d) prompting, by the fuel and exhaust pump computing device or controller, one of the one or more vehicles to accept, adjust, or deny (1) the amount of fuel to fill the fuel tank or (2) the amount of exhaust to empty the exhaust tank, and (e) in response to selection by the one of the one or more vehicles (1) to accept an amount of fuel or (2) to offload an amount of exhaust, initiating one or more corresponding fueling operations or exhaust offloading operations.

In an embodiment, a fuel and exhaust point of sales system may be included in each of the one or more fuel pumps and exhaust pumps, and the fuel and exhaust point of sales system may include the fuel and exhaust pump computing device or controller. The fuel and exhaust point of sales system may include a user interface configured to display prompts and transactions.

Another embodiment of the disclosure is directed to a method to provide a determined amount of fuel for a vehicle and a determined amount of captured exhaust to offload from a vehicle. The method may include, in response to arrival of a vehicle at a bay, (a) obtaining vehicle data from the aspect and/or via a signal associated with or of the vehicle, (b) determining a fuel tank level and an exhaust tank level based on the vehicle data, (c) determining a user history based on user data associated with the vehicle (d) prompting a user to proceed with one or more of a fuel operation or an exhaust offload operation based on the fuel tank level and the exhaust tank level, (e) in response to acceptance of the fuel operation, initiating the fuel operation, and (f) in response to acceptance of the exhaust offload operation, initiating the exhaust offload operation.

In an embodiment, the method may further include, subsequent to completion of the fuel operation and exhaust offload operation, requesting payment for fuel pumped and exhaust offloaded.

Another embodiment of the disclosure is directed to a non-transitory machine-readable storage medium storing processor-executable instructions that, when executed by one or more processors, cause the one or more processors to, determine proximity of a vehicle based on detection of one or more signals or physical characteristics of the vehicle. The instructions may, when executed by the one or more processors, in response to the vehicle being within a selected proximity of a fuel site, obtain data associated with the vehicle and a user associated with the vehicle from the one or more signals or physical characteristics. The instructions may, when executed by the one or more processors, determine a predicted amount of fuel to fill a fuel tank of the vehicle. The instructions may, when executed by the one or more processors, transmit the predicted amount of fuel to the user. The instructions may, when executed by the one or more processors, in response to reception of a selected amount of fuel, initiate fuel pumping operations. The instructions may, when executed by the one or more processors, in response to reception of a selected amount of exhaust, initiate exhaust offloading operations.

In an embodiment, the instructions may, when executed by the one or more processors, determine a predicted amount of exhaust to offload from an exhaust tank of the vehicle; transmit the predicted amount of exhaust to the user; and in response to reception of a selected amount of exhaust, initiate exhaust offloading operations. In another embodiment, the data associated with the vehicle may include a fuel tank level, a fuel tank capacity, an exhaust tank level, and/or an exhaust tank capacity. The predicted amount of fuel to fill the fuel tank may be based on the fuel tank level and the fuel tank capacity, and the predicted amount of exhaust to offload from the exhaust tank may be based on exhaust tank level and exhaust tank capacity. In another embodiment, the data associated with the vehicle may, rather than or in addition to previous embodiments, include vehicle mileage, last fueling station visited, vehicle miles per gallon, and exhaust emitted per mile. The predicted amount of fuel to fill the fuel tank may be based on the fuel tank level, vehicle mileage, last fueling station visited, vehicle miles per gallon, or some combination thereof, and the predicted amount of exhaust to offload from the exhaust tank may be based on exhaust tank level, vehicle mileage, last fueling station visited, exhaust emitted per gallon, or some combination thereof.

In another embodiment, the one or more signals or physical characteristics of the vehicle may include or comprise one or more of a Wi-Fi signal, a RFID signal, a NFC signal, a cellular signal, a Bluetooth signal, vehicle identification number (VIN), a license plate, a radio-frequency identification (RFID) tag, a sensor, or other transmitter configured to securely send vehicle information.

Still other aspects and advantages of these embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and may exist in various combinations and permutations.

### BRIEF DESCRIPTION OF DRAWINGS

These and other features, aspects, and advantages of the disclosure will become better understood with regard to the following descriptions, claims, and accompanying drawings. It is to be noted, however, that the drawings illustrate only several embodiments of the disclosure and, therefore, are not to be considered limiting of the scope of the disclosure.

FIG. 1 is a diagram illustrating a site utilizing a mobile productivity platform, according to one or more embodiments of the disclosure.

FIG. 2A, FIG. 2B, FIG. 2C, FIG. 2D, and FIG. 2E are simplified diagrams that illustrate computing devices to implement the mobile productivity platform, according to one or more embodiments of the disclosure.

FIG. 3 is a simplified diagram that illustrates controller to implement the mobile productivity platform, according to one or more embodiments of the disclosure.

FIG. 4A, FIG. 4B, FIG. 4C, and FIG. 4D are simplified diagrams that illustrate a novel implementation of a fuel and exhaust pump for transporting fuel to a vehicle and offloading exhaust from the vehicle in which the fuel and exhaust pump include two separate nozzles for fuel and for exhaust, and a touchscreen user interface to implement the mobile productivity platform, according to one or more embodiments of the disclosure.

FIG. 5A, FIG. 5B, FIG. 5C, FIG. 5D, FIG. 5E, FIG. 5F, FIG. 5G, FIG. 5H, and FIG. 5I are simplified diagrams illustrating, at least a part, of the mobile productivity platform on a user device

FIG. 6 is a flow chart illustrating utilization of a mobile productivity platform, according to one or more embodiments of the disclosure.

FIG. 7A and FIG. 7B are schematic diagrams that illustrate scalable greenhouse gas capture systems, utilizing the mobile productivity platform, for offloading captured greenhouse gas from a marine vessel that may include an exhaust or carbon capture device, according to one or more embodiments of the disclosure.

FIG. 8 is a schematic diagram that illustrates scalable greenhouse gas capture systems, utilizing the mobile productivity platform, for offloading captured greenhouse gas from a locomotive and/or rail car to a greenhouse gas holding tank and transporting the greenhouse gas from the greenhouse gas holding tank, via a transportation mechanism, for re-use, recycle, or permanent storage, according to one or more embodiments of the disclosure.

### DETAILED DESCRIPTION

So that the manner in which the features and advantages of the embodiments of the systems and methods disclosed herein, as well as others that will become apparent, may be understood in more detail, a more particular description of embodiments of systems and methods briefly summarized above may be had by reference to the following detailed description of embodiments thereof, in which one or more are further illustrated in the appended drawings, which form a part of this specification. It is to be noted, however, that the drawings illustrate only various embodiments of the systems and methods disclosed herein and are therefore not to be considered limiting of the scope of the systems and methods disclosed herein as it may include other effective embodiments as well.

Currently, fueling a transportation vehicle is a manual operation. A consumer may drive to a consumer store, park the transportation vehicle in front a fuel pump, exit the transportation vehicle, purchase an amount of fuel using a terminal on the fuel pump, and then pump fuel to the transportation vehicle. If the consumer utilizes cash, as opposed to a debit or credit card, the user then has to estimate the amount of fuel to pump to the transportation vehicle and pay for that amount inside the consumer store. In such examples, the user may overspend on fuel or not purchase enough fuel. Further, rewards systems for such transactions are typically facilitated via sign in, for example, such as using an email or username, or some other physical identification.

Other types of purchases (for example, for goods and/or services) are typically performed or transacted in the consumer store, or via a drive through as well, causing a consumer to potentially wait for an extended period of time in line, looking for a particular product (for example, goods and/or services), and/or wait while processing a payment or transaction via physical money or credit/debit card.

Accordingly, Applicant has recognized a need for a mobile productivity platform, and more particularly, to systems and methods that predict a consumer's order and allow the consumer to order products and services (for example, fuel via a fueling operation, offloading exhaust, ordering goods and/or services, and/or operations or services) based on various factors (for example, fuel tank levels, exhaust tank levels, vehicle history, order history, and/or other factors related to a driver and/or vehicle). The present disclosure is directed to embodiments of such systems and methods.

The present disclosure is generally directed to a mobile productivity platform, and more particularly, to systems and methods that predict a consumer's (or other user's) order and allow the consumer to order products and services (for example, fuel via a fueling operation, offloading exhaust, ordering goods and/or services, and/or operations or services) based on various factors (for example, fuel tank levels, exhaust tank levels, vehicle history, order history, and/or other factors related to a driver and/or vehicle). Such a mobile productivity platform may comprise or include a computing device and/or an application on a user device. The application may include a user interface. The computing device may include instructions to detect and connect to an approaching transportation vehicle and/or the application via a detector or sensor at a convenience store, a gas or fueling station, a service station, a restaurant, or other location providing goods and services. In a particular embodiment, and as noted, the detector or sensor may be positioned at the convenience store and gas or fueling station. The detector may be configured to detect a transportation vehicle, the user device, and/or other computing device associated with the user. The detector may, in an embodiment, discover the transportation vehicle, the user device, and/or other computing device associated with the user. In another embodiment, the detector may determine a position of the transportation vehicle. The detector may, in response to detection, discovery, and/or determination of the position of the vehicle, obtain data related to the user, the user device, the other computing device associated with the user, the transportation vehicle corresponding to or associated with the user, and/or from data storage (for example, data associated with an aspect, characteristic, and/or signal associated with or of the user and/or transportation vehicle stored in data storage). Once the detector has obtained the data, a computing device, in signal communication with the detector, may, using data received from the detector (or the user and/or transportation vehicle), determine a predicted amount of fuel to pump to the transportation vehicle, a predicted amount of exhaust to offload from the transportation vehicle, and/or a predicted good and/or service to purchase, among other predictions.

The predictions described may be based on various factors, the factors being included in the data obtained by the detector. The factors may include one or more of fuel tank level, exhaust tank level, current mileage, previous mileage at last time of fueling and/or exhaust offload, fueling history, exhaust offloading history, transportation vehicle diagnostics and/or status, and/or order/fueling/offloading history, among other factors. In an embodiment, the data obtained by the detector may be encrypted. Various encryption/decryption algorithms (for example, Rivest-Shamir-Adleman (RSA), Diffie-Hellman exchange, and/or other algorithms as will be understood by one skilled in the art) may be utilized to transfer data to/from the vehicle from/to the detector.

The detector may be included in or may be a computing device. The computing device may be configured to determine and/or predict an amount of fuel to pump to the transportation vehicle, an amount of exhaust to offload from the transportation vehicle, and/or another transaction to initiate (for example, order food, beverages, goods, and/or services). For example, the computing device may determine and/or predict the amount of fuel to pump to the transportation vehicle based on fueling history, the previous mileage and current mileage, and/or the fueling tank level. Similarly, the amount of exhaust to offload and/or other transactions may be determined and/or predicted. After a determination and/or prediction, the computing device may initiate operations associated with the determinations and/or predictions. In an example, the computing device may initiate the operation by transmitting a message to a user to accept or adjust such an amount (for example, an amount of fuel and/or exhaust) and, via user interaction, cause the operation to occur. In another embodiment, the computing device may initiate and control the operation for the duration of the operation. In yet another embodiment, such an operation may include physical interaction from the user (for example, placing a nozzle in the user's vehicle for fueling and/or offloading exhaust) or may be automated and controlled by the computing device (for example, via a combination of algorithms and automated or robotic elements).

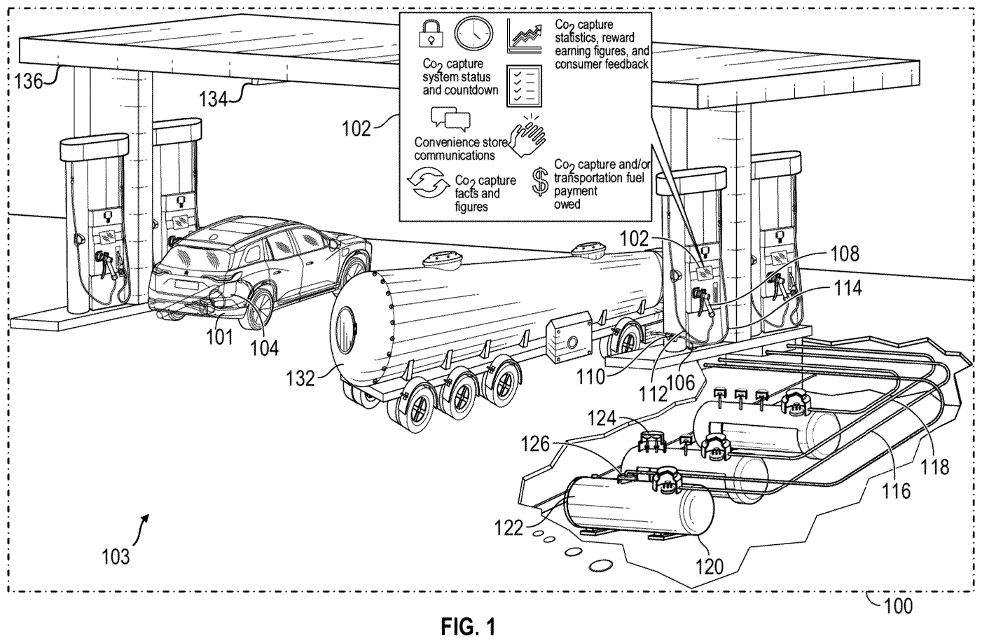

FIG. 1 is a schematic diagram illustrating a site utilizing a mobile productivity platform, according to one or more embodiments of the disclosure. The site 103 may include sets, rows, or islands of motor fuel and exhaust dispensers/receivers or fuel and exhaust pumps 106. The term motor fuel and exhaust dispenser/receiver may be used interchangeably with the term fuel and exhaust pumps 106. The fuel and exhaust pumps 106 may include various components to allow a motorist vehicle 101 (also referred to as a transportation vehicle) to offload combustion products, for example, exhaust, and/or other greenhouse gases from the air that are captured and stored in an on-board vehicle exhaust capture device 104, as well as to allow the motorist vehicle 101 or other vehicle to re-fuel.

In addition to motorist vehicle 101 utilizing the site 103, a variety of different types of vehicles, motor driven devices, and/or other mechanisms may utilize the scalable greenhouse gas capture system 100. A vehicle may include a car, a truck, a heavy vehicle (for example, delivery vehicle 132, semi-truck, or eighteen wheeler), a bus, heavy equipment, an internal combustion engine/electric hybrid vehicle, battery powered electric vehicle, and/or other vehicle types. Further, the fuel and exhaust pump 106 or a separate exhaust pump may be located in a variety of locations, such as at a convenience store, bus or truck terminal, truck stop, seaport, river port, service station or store, motorist vehicle dealership, parking lot or garage, airport, and/or any other location where a motorist vehicle 101 or other vehicle may travel. While description for FIG. 1 includes offloading exhaust from a motorist vehicle 101, it will be understood by those skilled in the art that exhaust may be offloaded from the other types of vehicles, described herein, or other equipment, for example, such as airplanes, boats/ships/marine vessels, or any other vehicle that may produce exhaust or greenhouse gases, equipment, heavy equipment, or any other mobile, moveable, non-static or dynamic exhaust or greenhouse gas capture device.

The motorist vehicle 101 may include, as noted, an on-board vehicle exhaust capture device 104, an on-board carbon capture device, or an on-board greenhouse gas capture device. As will be understood, on-board vehicle exhaust capture device 104 may be used interchangeably with on-board carbon capture device and/or on-board greenhouse gas capture device. The on-board vehicle exhaust capture device 104 may be one of a variety of devices to capture exhaust or other components of exhaust from an internal combustion engine of a motorist vehicle or other vehicle. One such device may capture the total or varying portions of exhaust produced by the internal combustion engine. In such embodiments, the cost of the on-board vehicle exhaust capture device 104 may be off-set by the lack of expense for a catalytic converter, which may potentially no longer be utilized as substantial amounts of exhaust may be captured. In another embodiment, the on-board vehicle exhaust capture device 104 may be designed or configured to capture carbon dioxide or filter carbon dioxide from exhaust and then capture the filtered carbon dioxide. Such configurations may additionally capture some portion of nitrogen and/or water, among other chemicals (for example, SOₓ, NOₓ, and/or other chemicals). The on-board vehicle exhaust capture device 104 may be disposed downstream of the catalytic converter of the motorist vehicle 101. The on-board vehicle exhaust capture device 104 may capture the exhaust or a portion of the exhaust produced after exhaust produced by an internal combustion engine passes through the catalytic converter. The on-board vehicle exhaust capture device 104 may be configured to capture carbon dioxide, greenhouse gases, all or portions of exhaust of an internal combustion engine vehicle, methane, carbon monoxide, nitrogen dioxide, sulfur dioxide, benzene, formaldehyde, polycyclic hydrocarbons, other particulate matter, other trace chemicals, and/or some combination thereof. The on-board vehicle exhaust capture device 104 may inadvertently capture trace amounts of other chemicals and/or water. The on-board vehicle exhaust capture device 104 may include a compressor to compress the exhaust or carbon dioxide, to ensure that a large quantity of carbon dioxide may be stored on the motorist vehicle 101. The on-board vehicle exhaust capture device 104 may include components to convert captured carbon dioxide, which may or may not include other chemicals (for example, nitrogen), to a liquid. In such embodiments, a cooling or refrigeration unit may be included on-board the motorist vehicle 101 and/or on-site at the scalable greenhouse gas capture system 100 to ensure that the liquefied carbon dioxide may be stored at the proper temperature, as will be understood by those skilled in the art.

The on-board vehicle exhaust capture device 104 may include a filter media or catalyst to capture carbon dioxide within a solid, for example, through adsorption or absorption. The filter or catalyst may be arranged in a fixed bed. Thus, the catalyst may be included as a fixed catalyst. As exhaust flows through the fixed catalyst or filter media, carbon dioxide may be adsorbed within pores of the catalyst or filter media or otherwise attach to or bond to the catalyst/filter media. To remove the carbon dioxide, the on-board vehicle exhaust capture device 104 may include a heating element to heat the catalyst or medium storing the carbon dioxide to release the carbon dioxide, for example, the carbon dioxide to be released as a gas. Thus, heat may be efficiently used through an existing on-board process and recycled to the unit instead of “wasted.” In another embodiment, the fixed catalyst may be included in a removable module. To remove carbon dioxide stored in the fixed catalyst, a user may remove the removable module and place or insert the module in a corresponding receptacle at the fuel and exhaust pump 106. Upon reception of the removable module, the fuel and exhaust pump 106 may offer a new removable module for insertion into the motorist vehicle or other vehicle. In one or more embodiments, the filter or catalyst may be included in a fluid. The fluid may capture or absorb the carbon dioxide as carbon dioxide passes through the fluid. To remove the carbon dioxide, the on-board vehicle exhaust capture device 104 may include a heating element to heat the fluid storing the carbon dioxide to release the carbon dioxide, for example, the carbon dioxide to be released as a gas. In another example, the carbon dioxide may be removed from the fluid via components or devices at the scalable greenhouse gas capture system 100.

For example, if the carbon dioxide/greenhouse gases are captured in a fluid or fluid carried catalyst, a motorist or user may offload the fluid/catalyst at the fuel and exhaust pump 106. The fluid/catalyst may be transported to a tank or intermediate holding tank. The fluid/catalyst may be heated in the tank to extract the carbon dioxide from the fluid/catalyst. The carbon dioxide may then be transferred to an exhaust holding tank 122. Further, the fuel and exhaust pump 106 may be configured to provide either new fluid/catalyst or recycled fluid/catalyst, for example, fluid/catalyst that has had carbon dioxide removed. In yet another example, the scalable greenhouse gas capture system 100 may capture carbon dioxide from a similar motorist vehicle or other vehicle that includes a liquid arranged and designed to capture greenhouse gases/carbon dioxide. In such examples, the motorist vehicle or vehicle may include a regenerative loop. As an absorbent liquid flows through a cool part or portion of a loop, the liquid may absorb carbon dioxide/greenhouse gases. The liquid may then flow to a hot part or portion of the loop. As the liquid heats up, the liquid may release the absorbed carbon dioxide/greenhouse gases. The released carbon dioxide/greenhouse gases may flow to a compressor and/or be stored on-board the vehicle.

The on-board vehicle exhaust capture device 104 may capture anywhere up to 100% of the exhaust of a motorist vehicle 101. In one or more embodiments, the on-board vehicle exhaust capture device 104 may capture at least 10%, at least 20%, at least 25%, at least 30%, at least 40%, at least 50%, at least 60%, at least 70%, at least 75%, at least 80%, at least 90% or more of the carbon dioxide in the exhaust that results from on-board vehicle combustion. The on-board vehicle exhaust capture device 104 may include a bypass device to allow for exhaust to be released to the atmosphere when the on-board vehicle exhaust capture device 104 is at capacity. The on-board vehicle exhaust capture device 104 may include a range limiter to prevent the motorist vehicle 101 from traveling past a specified distance when the on-board vehicle exhaust capture device 104 is at capacity. The on-board vehicle exhaust capture device 104 may store an amount of exhaust or carbon dioxide, for example, such as about 100 pounds or less, about 500 pounds, about 1,000 pounds, about 5,000 pounds, or more. In any of the embodiments described herein, the scalable greenhouse gas capture system 100 may be configured to offload any form of captured exhaust, for example, compressed gas or liquid, adsorbed into solids adsorbents, and/or among other forms. In other embodiments, the scalable greenhouse gas capture system 100 may include a plurality of pumps, compressors, nozzles, and/or other options to accommodate varying and/or different types of on-board vehicle exhaust capture devices.

As noted, the offloaded exhaust may be in various forms, such as a gas, liquid, or solid. The offloaded exhaust may include or may comprise carbon dioxide. In addition to the carbon dioxide, the offloaded exhaust may include amounts of oxygen, nitrogen, and/or water. The liquid may comprise different combinations of carbon dioxide and other chemicals, including, but not limited to, mixtures comprising about 96 mol % carbon dioxide and about 4 mol % nitrogen; about 93 mol % carbon dioxide, about 4 mol % nitrogen, and about 3 mol % water; or about 95 mol % carbon dioxide, about 4 mol % nitrogen, and about 1 mol % water. Further, as environmental conditions (for example, ambient temperatures) vary, the mixture composition may vary (for example, as temperatures increase the liquid may include more water in relation to carbon dioxide, while the amount of water may be reduced in cooler temperatures). In an embodiment, the exhaust may include a portion or amount of water. In such examples, prior to further storage or processing at the scalable greenhouse capture system 100, the water may be removed. If water is left in exhaust (for example, liquid carbon dioxide), the water may freeze and cause a blockage or may cause other issues, such as corrosion to the pipe and equipment. To remove the water, the on-board vehicle exhaust capture device 104 or the fuel and exhaust pumps 106 may include a dryer. The dryer may include a desiccant or be otherwise configured to remove the water, thus ensuring proper and continued operation of the scalable greenhouse capture system 100.

While a motorist vehicle 101, such as a car, truck, boat or other motorist driven vehicle may include an on-board vehicle exhaust capture device 104 to capture exhaust produced by an internal combustion engine, the on-board vehicle exhaust capture device 104 may also be configured to capture specific chemicals or greenhouse gases directly from the air, i.e., the atmospheric air exterior to the motorist vehicle 101 or vehicle. In such embodiments, the on-board vehicle exhaust capture device 104 may be included in or on a variety of vehicles, for example, such as an electric vehicle, a fuel-cell based vehicle, a natural gas based vehicle, a hydrogen powered vehicle any other alternative fuel based vehicle, heavy vehicles, trucks, eighteen wheelers, marine vessels, airplanes or aircraft, and/or some combination thereof. During operation of the motorist vehicle 101, air may flow into or through the on-board vehicle exhaust capture device 104. The on-board vehicle exhaust capture device 104 may capture greenhouse gases, for example, carbon dioxide, from the air flow. For convenience, such greenhouse gases captured in this way may be referred to as exhaust gases. In another embodiment, the on-board vehicle exhaust capture device 104 may solely capture other chemicals or greenhouse gases from the air. As used herein, “fuel” may include a variety of different materials or energy utilized to power a vehicle, or equipment, for example, gasoline, diesel, ethanol, combinations of different renewable and non-renewable fuels, electricity, hydrogen, Liquefied petroleum gas, natural gas, and/or some combination thereof.

When a motorist vehicle 101 drives into or approaches the site 103, parks or stops adjacent to the fuel and exhaust pump 106, and/or drives underneath or into a bay 136, a detector 134 may detect or discover the motorist vehicle 101 and/or a user device associated with or corresponding to the motorist vehicle 101. The detector 134 may include an image capture device and/or computing device configured to detect and connect to one or more varying devices. Detection or discovery may include scanning for an identifier associated with the motorist vehicle 101 and/or detecting a signal from a device associated with and/or corresponding to the motorist vehicle 101 and connecting to the device. For example, the detector 134 may detect or discover a Wi-Fi signal, a RFID signal, a NFC signal, a cellular signal, a Bluetooth signal, or other signal from a vehicle and/or device. In another embodiment, the detector 134 may determine a position of the motorist vehicle 101 (for example, using a geolocation device and/or other devices, as will be understood by one skilled in the art). The device may include a mobile device, a device embedded within the motorist vehicle (for example, a computing device or circuitry of the motorist vehicle 101), a tag (for example, a radio-frequency identification (RFID) tag), and/or another storage or memory device. The detector 134 may, upon detection of the signal, connect to the device. The detector 134 may request and/or obtain data from the device and/or obtain data based on identifier associated with the motorist vehicle 101. The data may include one or more of a fuel tank total capacity, a fuel tank level, exhaust tank total capacity, exhaust tank level, miles per gallon or fuel efficiency, exhaust emitted per gallon, mileage of the vehicle, diagnostic data, data related to other aspects and/or characteristics of the vehicle, fuel transaction history, exhaust transaction history, a last station or site or fueling station visited, transaction data related to the last station or site visited, and/or account information and wherein the data associated with the vehicle further includes mileage of the vehicle at the last station visited. Further, if the detector 134 includes an image capture device, the detector 134 may capture some aspect and/or characteristic of the motorist vehicle (for example, a VIN, a license plate number, exterior flaws or characteristics of the motorist vehicle 101, and/or other characteristics). In another embodiment, the detector 134 may include a geolocation device to obtain coordinates associated with a location of a vehicle. In yet another embodiment, the detector 134 may comprise one or more detection devices positioned throughout the bay 136 and/or a canopy associated with the bay.

The detector 134 and/or the computing device (the computing device including, comprising, or connected to the detector 134), as noted, may connect to a device associated with and/or corresponding to the motorist vehicle 101. Such a connection may be a secure connection. In other words, the data connection between the detector 134 and device may be secured via a password and/or encrypted or secured via a security protocol (for example, such as a hypertext transfer protocol (HTTPS), transport secure layer (TLS), secure socket layer (SSL), and/or other security protocol, as will be understood by one skilled in the art). Rather than or in addition to the secure connection, data transmitted to the computing device may be encrypted prior to such transmission and decrypted, via the computing device, after reception. The encryption/decryption process may be a Rivest-Shamir-Adleman (RSA) algorithm, a Diffie-Hellman key exchange algorithm, and/or other encryption/decryption algorithm, as will be understood by one skilled in the art.

For example, if a RSA algorithm is utilized, the computing device and the device associated with and/or corresponding to the motorist vehicle 101 may share private keys. Sharing the private keys may occur upon an initialization or sign-up operation. In other words, prior to such a connection being formed or the motorist vehicle 101 being recognized by the detector 134 and/or computing device, the motorist vehicle 101 (or the device) may register with the detector 134 and/or computing device. Registration may include providing user information, motorist vehicle information, and/or sharing private keys between the motorist vehicle 101 and the computing device. Using the private keys, the motorist vehicle 101 (or device) and the computing device (or detector 134) may encrypt data to be transmitted. The receiving party (for example, the motorist vehicle 101 (or device) and the computing device (or detector 134)) may utilize a public key to decrypt the encrypted received data. The example described is an example, and it will be understood that other encryption/decryption algorithms may be utilized to encrypt and decrypt data transmitted between the motorist vehicle 101 (or device) and the computing device (or detector 134).

Once the detector 134 has received the data, the detector 134 (or computing device) may make one or more determinations and/or predictions. The determinations and/or predictions may include determining an amount of fuel to provide or suggest providing to the motorist vehicle 101, determining an amount of exhaust to pump or suggest pumping from the motorist vehicle 101, and/or determining other goods and/or services to offer the motorist or user. The detector 134 and/or computing device may generate a user interface, in conjunction with an algorithm stored in the motorist's device, for display on the motorist's device. The detector 134 and/or computing device may generate a user interface 102 for the fuel and exhaust pump 106 and/or for a motorist's device. The user interface 102 (or the user interface of the motorist's device) may include various options, actions, and/or information. The user interface 102 (or the user interface of the motorist's device) may prompt the motorist or user to pay for, adjust, or deny/reject a predicted amount of fuel; prompt the motorist or user to pay for, adjust, deny/reject, or receive payment and/or rewards to offload a predicted amount of exhaust; prompt the motorist to initiate a fueling or exhaust offloading operation; prompt the motorist or user to insert a fuel nozzle 110 into the motorist vehicle's 101 corresponding fuel port 128; prompt the motorist or user to insert an exhaust nozzle 108 into the motorist vehicle's 101 corresponding exhaust port 130; provide analysis and statistics regarding offloaded exhaust; provide an offloaded exhaust history of the motorist, other motorists, and/or users; provide incentives based on offloaded exhaust of the motorist vehicle 101; recommend and/or determine types of services and/or goods (for example, based on data associated with the motorist vehicle 101 and/or a user); determine and/or display the carbon intensity of fuel and/or fuel consumed by the motorist vehicle 101; and/or offer receipt after fuel or energy has been provided and/or exhaust offloaded.

The user interface 102 (or the user interface of the motorist's device) may include options to transact payment, via either credit card, debit card, mobile payment applications, cryptocurrency, and/or other forms of suitable payment.

After the motorist or user initiates payment and selects fuel and/or exhaust offload options, as noted, the motorist or user may be prompted to insert the fuel nozzle 110 into the motorist vehicle's 101 corresponding fuel port 128 and/or insert an exhaust nozzle 108 into the motorist vehicle's 101 corresponding exhaust port 130, based on whether the motorist or user selects to fuel the motorist vehicle 101 and/or offload exhaust from the motorist vehicle 101. The fuel nozzle 110 and/or the exhaust nozzle 108 may include sensors or pins to determine or provide data to a computing device to determine whether each respective nozzle has been inserted into the corresponding port on the motorist vehicle 101. In another embodiment, the user interface 102 may issue a prompt to the motorist or user to indicate when the fuel nozzle 110 and/or exhaust nozzle 108 is inserted into the corresponding port on the motorist vehicle 101. In another embodiment, the exhaust nozzle 108 may include additional safety features to ensure that the exhaust or carbon dioxide, whether compressed, not compressed, or in a liquid form, does not leak during an offload operation. Such features may allow the exhaust nozzle 108 to sealingly engage with the exhaust port 130 of the motorist vehicle 101. For example, the exhaust nozzle 108 may include a male portion surrounded by a gasket, o-ring, or another surround to create a seal between the exhaust nozzle 108 and exhaust port 130 of the motorist vehicle 101, the exhaust port 130 including a female portion corresponding to the male portion of the exhaust nozzle 108. The seal, as noted, may prevent leakage of exhaust or carbon dioxide, thus preventing potential injury or harm to a motorist or user and/or loss of exhaust or carbon dioxide to atmosphere.

In another embodiment, the exhaust nozzle 108 may include threads, teeth, ramps, linkages, or magnets. The threads may correspond to threads disposed or located on the inside of the exhaust port. As a motorist or user inserts the exhaust nozzle 108 into the exhaust port 130, a portion of the exhaust nozzle 108 may be retained within the exhaust port 130 and may align the threads of the exhaust nozzle 108 with the inner threads of the exhaust port 130. The user may then twist another portion or movable portion of the exhaust nozzle 108 to tighten the exhaust nozzle 108 in the exhaust port 130 to create a seal and/or lock. Other features may be included on the exhaust nozzle 108, such as locking or latching components. The locks or latches may correspond to features included in the exhaust port 130 of the motorist vehicle 101. As the exhaust nozzle 108 is inserted into the exhaust port 130, the locking or latching features of the exhaust nozzle 108 may lock or latch into or onto the corresponding features of the exhaust port 130, thus preventing a motorist or user from removing the exhaust nozzle 108 during exhaust offload. In such embodiments the exhaust nozzle 108 may include a feature to unlock or unlatch the exhaust nozzle 108 from the exhaust port 130. Such a feature may be actuated via control signals from the fuel and exhaust pump 106, via the user interface 102, and/or via a button, switch, or handle on the exhaust nozzle 108. In another embodiment, the exhaust nozzle 108 may be a quick release nozzle. In yet another embodiment, the exhaust nozzle 108 may include notches or teeth corresponding to protrusions in the exhaust port 130. As a motorist or user inserts the exhaust nozzle 108 into the exhaust port 130, the notches may align with the protrusions. Further, channels along the exhaust nozzle may allow for the motorist or user to perform a semi or quarter turn to lock and/or seal the exhaust nozzle 108 in place.

In another embodiment, the detector 134 and/or computing device may control fueling and exhaust offloading operations, via automated and/or robotic elements. Thus, once a motorist or user accepts an amount of fuel, an amount of exhaust, and/or other goods and/or service, then the detector 134 and/or computing device may initiate and execute the corresponding operation.

In another embodiment, after a motorist or user has inserted the fuel nozzle 110 into the motorist vehicle's 101 corresponding fuel port 128 and/or the exhaust nozzle 108 into the motorist vehicle's 101 corresponding exhaust port 130, the fuel and exhaust pump 106 may begin pumping/dispensing fuel to the motorist vehicle 101 and/or pumping/receiving exhaust from the motorist vehicle 101. The fueling and exhaust offload operation may take place in a sequential order. For example, the fuel may be pumped to the motorist vehicle 101 first, followed by pumping the exhaust from the motorist vehicle 101. In another embodiment, the exhaust may be removed first, while the fuel is pumped afterwards. In yet another embodiment, such operations, for example, exhaust removal and/or fuel dispensing, may occur simultaneously, substantially simultaneously, may overlap for a period of time, or one operation may occur while the other does not (for example, re-fueling with no exhaust offload or exhaust offloading with no re-fueling).

During exhaust offloading and/or re-fueling or re-charging, the user interface 102 may include or display various characteristics or statistics related to exhaust offload and/or fuel dispensing. For example, the user interface 102 may display the amount of exhaust or carbon dioxide that a user has offloaded. The user interface 102 may display the amount of exhaust or carbon dioxide that has been offloaded in a city, in a state, in a country, and/or worldwide. The user interface 102 may display the impact of such offload operations, for example, that a certain amount of offloaded exhaust or carbon dioxide is equivalent to planting a certain number of trees, removing a number of conventional internal combustion engine vehicles from the road, and/or reducing the carbon intensity of particular fuels utilized, or, through separate use of machine learning and/or artificial intelligence, offer lifetime carbon emissions/savings compared to certain accepted baselines. The user interface 102 may display a rolling total of exhaust offloaded in the current operation and, if a cost is associated with exhaust offloading, the cost. The user interface 102 may also display advertisements and/or other messages. The user interface 102 may also display a motorist's or user's reward points in relation to exhaust or carbon dioxide offload. In such examples, as a motorist or user offloads exhaust, the motorist or user may receive incentives, payment, or rewards (for the amount of offloaded exhaust) from the convenience store, the entity owning or operating the fuel and exhaust pump 106, or the entity owning or operating an exhaust pump. Such incentives or rewards may include discounts on fuel or discounts on goods or services sold at the store associated with the fuel and exhaust pump 106. Further, such incentives may be offered by third parties for particular amounts of offloaded exhaust. Stated another way, a motorist or user may be given an option to offload a particular amount of exhaust for an incentive from a third party. For example, a motorist or user may be offered a number of points or miles, by an airline, for corresponding amounts of offloaded exhaust. Such amounts may be accounted for within a single offloading session or cumulatively over multiple offloading sessions through a deployed program.

The fuel and exhaust pump 106 may include pipes, for example, fuel pipe 114 and exhaust pipe 112, connected to and in fluid communication with the fuel nozzle 110 and exhaust nozzle 108, respectively. The fuel pipe 114 may connect to and be in fluid communication with a fuel tank 120 or one or more fuel tanks. The fuel pipe 114 may be a flexible hose or other flexible pipe. Fuel of the scalable greenhouse gas system 100 may be stored in a fuel tank 120, below- or above-grade fuel tanks, or fuel holding tanks. Fuel tank 120 may include, hold, or store varying types and combinations of gasoline, diesel, ethanol, and/or other bio or renewable fuels, or hydrogen or ammonia. The scalable greenhouse gas capture system 100 may include one or more different fuel tanks, each storing the same or different fuel types. Fuel may flow from the fuel tank 120 through, for example, pipe 118 to the fuel and exhaust pump 106 and, thus, through fuel pipe 114 to the fuel nozzle 110 to the motorist vehicle 101. The exhaust pipe 112 may connect to and be in fluid communication with an underground exhaust holding tank (such as exhaust holding tank 122), an above-ground horizontally oriented exhaust tank, and/or an above-ground vertically oriented exhaust tank. The exhaust pipe 112 may be a flexible hose, a flexible pipe, or any type of pipe able to withstand, potentially, high pressure and/or low temperatures. The exhaust holding tank 122 may include or have a capacity to store an amount of captured exhaust. The exhaust holding tank 122 may be configured to or have a capacity to hold exhaust from a number of vehicles for example, such as, 50 vehicles, 100 vehicles, 200 vehicles, 500 vehicles, or more. The exhaust holding tank 122 may be configured to hold an amount of exhaust equivalent to a number of motorist vehicles offloading exhaust each day for about several days, 1 week, 2 weeks, 1 month, or more. In such examples, the exhaust holding tank's 122 size may be determined based on how frequently a delivery vehicle may pick up the exhaust from the exhaust holding tank. The exhaust holding tank 122 may be configured to hold the exhaust at high pressure and/or low temperatures or, if the exhaust is offloaded as a liquid, hold the exhaust at about 300 psig to about 350 psig at low temperatures. As exhaust or carbon dioxide is pumped/transported from the motorist vehicle 101, the exhaust may flow through the exhaust nozzle 108 to the exhaust pipe 112 to pipe 116 and finally to the exhaust holding tank 122. In an embodiment, the scalable greenhouse gas capture system 100 may include one or more fuel tanks and one or more exhaust holding tanks. In such embodiments, the one or more exhaust tanks may be located, disposed, or situated above-grade and/or below-grade.

In an embodiment, the fuel tank 120 may include a delivery vehicle port 124 or ports. The delivery vehicle port 124 or ports may allow for delivery vehicle connection. Such a connection may allow for the delivery vehicle 132 to transfer fuel to the fuel tank 120 from the delivery vehicle 132, for example, to re-fill the fuel tank 120. In another embodiment, the exhaust holding tank 122 may include a delivery vehicle port 124 or ports. The delivery vehicle port 126 or ports may allow for delivery vehicle connection. Such a connection may allow for the delivery vehicle 132 to transfer exhaust or carbon dioxide from the exhaust holding tank 122 to the delivery vehicle 132, for example, to empty the exhaust holding tank 122.

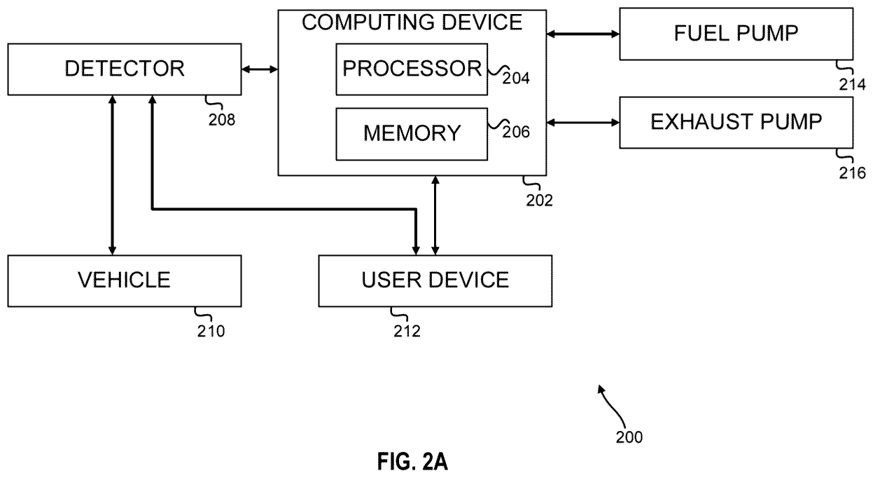

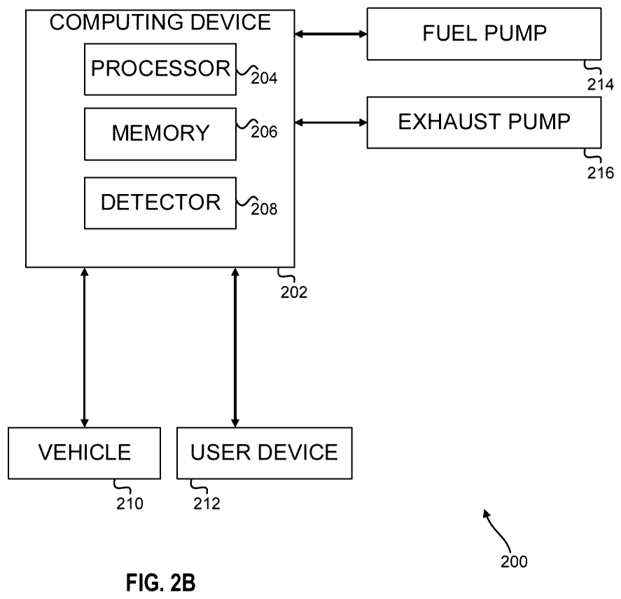

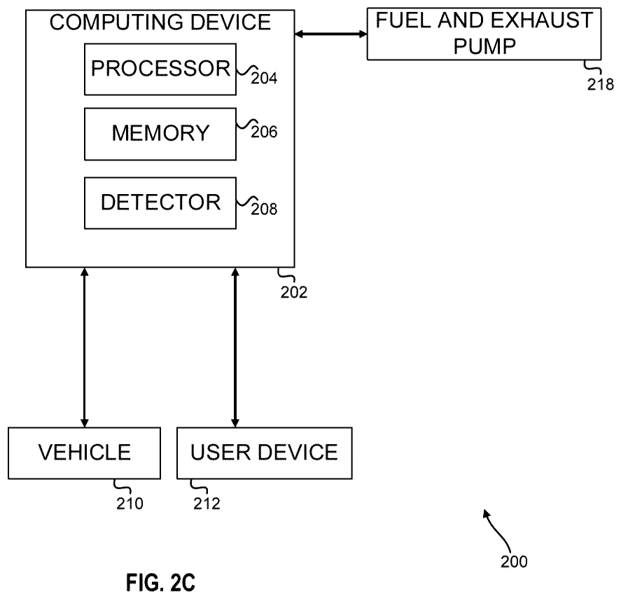

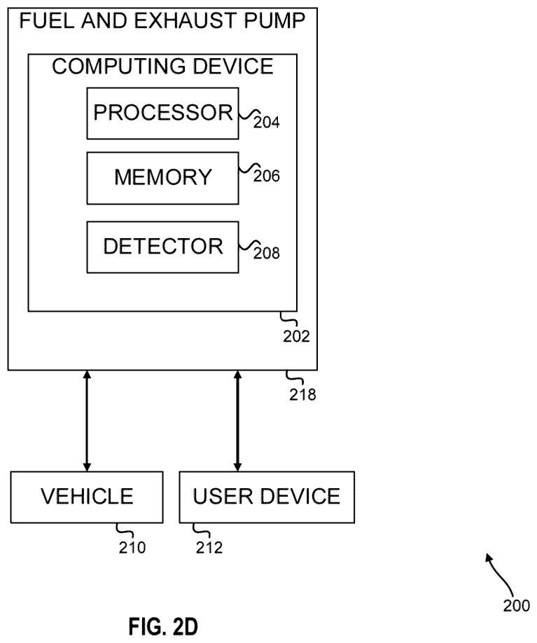

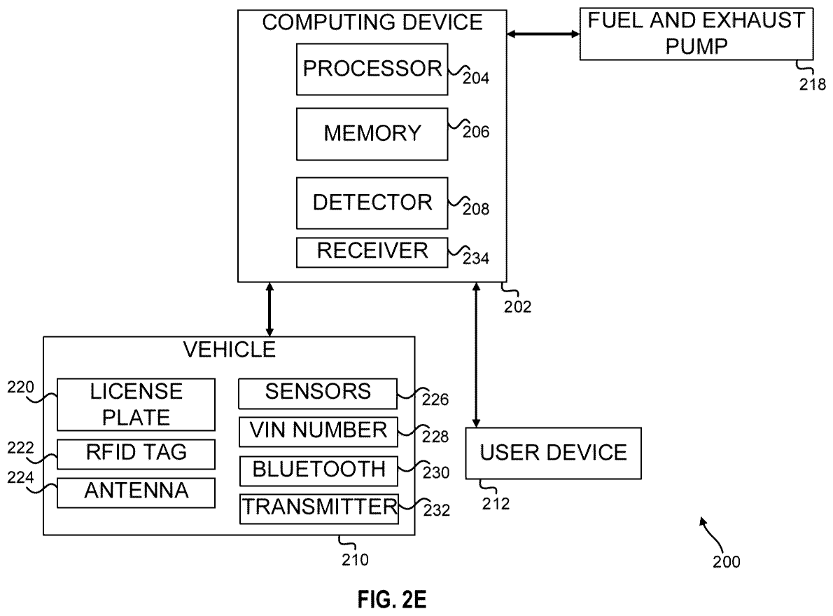

FIG. 2A, FIG. 2B, FIG. 2C, FIG. 2D, and FIG. 2E are simplified diagrams that illustrate systems to implement the mobile productivity platform, according to one or more embodiments of the disclosure. Turning first to FIG. 2A, the system 200 may include various components. The system may include a detector 208 in signal communication with a computing device 202. The computing device 202 may include at least one processor 204 and a memory 206. The memory 206 may store instructions executable by the processor 204 (for example, to perform the operations described herein). The computing device 202 may be in signal communication with a fuel pump 214 and/or an exhaust pump 216. The detector 208 may detect a vehicle 210 or some aspect and/or characteristic of a vehicle 210. The detector 208 may determine or obtain a profile associated with a user based on such a detection. The profile may include or indicate various aspects and/or characteristic of the vehicle. In another embodiment, the detector 208 may obtain data related to the vehicle 210 directly from the vehicle 210. The detector 208 may connect to the vehicle 210 or a device of the vehicle 210 (for example, via a secure connection) and obtain information therefrom. The detector 208 (and/or in another embodiment, the computing device 202) may also connect to and/or discover or detect a user device 212. In another embodiment, the detector 208 may determine availability of one or more signals and/or characteristics of the vehicle 210 and/or user device 212. The detector 208 may obtain vehicle data and/or user data from the user device 212 or based on a profile associated with the user device 212.

In an embodiment, the detector 208 may comprise an image capture device, a RFID reader, a Bluetooth based reader or device, a transmitter/receiver (for example, to receive and/or transmit signals via Wi-Fi or other wireless signals), and/or various other sensors to detect a vehicle 210. As such, the detector 208 may detect a vehicle 210 and/or user device 212 (for example, the user device 212 associated with and/or corresponding to the vehicle 210).

The computing device 202 may receive the vehicle and/or user data from the detector 208 and/or directly from the user device 212 and/or the vehicle 210. The computing device 202 may determine a number of predictions and/or suggestions to provide to the user, via the user device 212. For example, the computing device 202 may provide a prediction and/or suggestion on the amount of fuel to provide to the vehicle 210, an amount of exhaust to offload from the vehicle 210, and/or a number of goods and/or services that the user may purchase (for example, food, drinks, vehicle maintenance, and/or other goods or services).

In an embodiment and as illustrated in FIG. 2B, the computing device 202 may include the detector 208. As illustrated in FIG. 2C, the fuel pump and the exhaust pump may be one component or device (for example, a fuel and exhaust pump 218). In yet another embodiment, and as illustrated in FIG. 2D, the computing device 202 may be included in or a may be a part of the fuel and exhaust pump 218. In such an embodiment, the detector 208 may detect the vehicle 210 as the vehicle 210 pulls adjacent to the fuel and exhaust pump 218.

Turning to FIG. 2E, the computing device 202 may, via a receiver 234, receive a number of aspects or characteristics of the vehicle 210. For example, the detector 208 may capture an image of the license plate 220 of the vehicle 210 and obtain information related to the vehicle based on the license plate number. The computing device may store such data with identifiers, such as the license plate number. Thus, when the license plate number is read, the computing device may call the data associated with such an identifier. The detector 208 may also obtain data from the vehicle 210 via an RFID tag 222, via an antenna 224, via one or more sensors 226, based on a vehicle identification number (VIN) 228, via Bluetooth 230, and/or via another transmitter 232. Thus, the computing device 202 and/or detector 208 may receive data regarding the vehicle, such as fuel tank total capacity, a fuel tank level, exhaust tank total capacity, exhaust tank level, miles per gallon or fuel efficiency, exhaust emitted per gallon, mileage of the vehicle, diagnostic data, data related to other aspects and/or characteristics of the vehicle, fuel transaction history, exhaust transaction history, a last station or site visited, transaction data related to the last station or site visited, goods and/or service purchase or order history, and/or account information. The predictions and/or suggestions noted above may be determined by the computing device 202 based on the aspects or characteristics previously noted.

Further, based on these predictions and/or suggestions, the computing device 202 may initiate and/or execute fueling and/or exhaust offloading operations via the fuel and exhaust pump 218 (or via the fuel pump 214 and/or exhaust pump 216).

The term “computing device” is used herein to refer to any one or all of programmable logic controllers (PLCs), controllers, supervisory controllers, programmable automation controllers (PACs), industrial computers, servers, virtual computing devices or environments, desktop computers, personal data assistants (PDAs), laptop computers, tablet computers, smart books, palm-top computers, personal computers, smartphones, cloud based computing devices, distributed computing devices, and similar electronic devices equipped with at least a processor and any other physical components necessarily to perform the various operations described herein.

The term “server” or “server device” is used to refer to any computing device capable of functioning as a server, such as a master exchange server, web server, mail server, document server, or any other type of server. A server may be a dedicated computing device or a server module (for example, an application) hosted by a computing device that causes the computing device to operate as a server. A server module (for example, server application) may be a full function server module, or a light or secondary server module (for example, light or secondary server application) that is configured to provide synchronization services among the dynamic databases on computing devices. A light server or secondary server may be a slimmed-down version of server type functionality that can be implemented on a computing device, such as a smart phone, thereby enabling it to function as an Internet server (for example, an enterprise email server) only to the extent necessary to provide the functionality described herein.

The computing devices described above and herein may include a machine-readable storage medium (also referred to as memory) and one or more processors. As used herein, a “machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (for example, hard drive), a solid state drive, any type of storage disc, and the like, or a combination thereof. The memory may store or include instructions executable by the processor. As used herein, a “processor” may include, for example one processor or multiple processors included in a single device or distributed across multiple computing devices. The processor may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

As used herein, “signal communication” refers to electric communication such as hard wiring two components together or wireless communication, as understood by those skilled in the art. For example, wireless communication may be Wi-Fi®, Bluetooth®, ZigBee, or forms of near field communications. In addition, signal communication may include one or more intermediate controllers or relays disposed between elements that are in signal communication with one another.

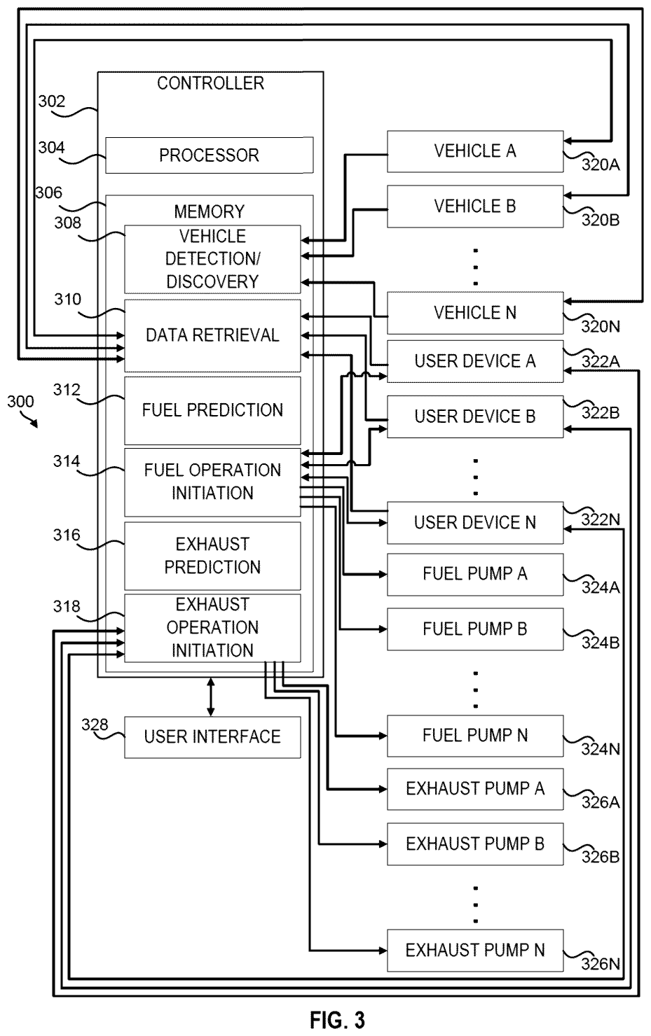

FIG. 3 is a simplified diagram that illustrates a controller to implement the mobile productivity platform, according to one or more embodiments of the disclosure. In an embodiment, the controller may be another type of computing device. In another embodiment, the controller 302 may be one or more controllers, a supervisory controller, programmable logic controller (PLC), or, as noted, another type of computing device. The controller 302 may include other components and/or devices, such as a detector, and/or may be a part of another device (for example, a fuel and/or exhaust pump). Further, the controller 302 may be in signal communication with other controllers, other computing devices, sensors, detectors, and/or other devices positioned throughout and/or external to a site or station.

The controller may include a machine-readable storage medium (for example, memory 306) and one or more processors (for example, processor 304). The controller 302 may include, as noted instructions stored in memory, such as instruction 308 for vehicle detection and/or discovery. The instructions 308 may also determine a vehicle position. Such instructions may be executed continuously or substantially continuously, to detect any new, approaching, and/or incoming vehicles (for example, vehicle 320A, 320B, and up to 320N). As a vehicle 320A, 320B, and up to 320N approaches a site, the controller 302 may detect the approaching vehicle 320A, 320B, and up to 320N. The controller 302 may utilize a detector, sensors, and/or other devices to detect the vehicle 320A, 320B, and up to 320N.

Upon detection of a vehicle 320A, 320B, and up to 320N, instructions 310 may be executed to obtain data from the vehicle 320A, 320B, and up to 320N and/or a user device 322A, 322B, and up to 322N. The controller 302 may establish a secure communication channel with the vehicle 320A, 320B, and up to 320N and/or the user device 322A, 322B, and up to 322N. once the secure communication is established, the controller 302 may obtain or request data from the vehicle 320A, 320B, and up to 320N and/or the user device 322A, 322B, and up to 322N. The data may include fuel tank total capacity, a fuel tank level, exhaust tank total capacity, exhaust tank level, miles per gallon or fuel efficiency, exhaust emitted per gallon, mileage of the vehicle, diagnostic data, data related to other aspects and/or characteristics of the vehicle, fuel transaction history, exhaust transaction history, a last station or site visited, transaction data related to the last station or site visited, goods and/or service purchase or order history, and/or account information.

In another embodiment, controller 302 may obtain or request data from storage or memory. The controller 302 may utilize some aspect and/or characteristics obtained from the vehicle 320A, 320B, and up to 320N to obtain the data associated with that vehicle 320A, 320B, and up to 320N. In such examples, the data may be stored in the storage or memory with an identifier. The identifier may be the aspect and/or characteristics associated with the vehicle 320A, 320B, and up to 320N (for example, a license plate number, VIN, and/or other identifying characteristic).

Once data is received or retrieved, instructions 312 and instructions 316 may be executed to predict an amount of fuel to pump to the vehicle 320A, 320B, and up to 320N and an amount of exhaust to pump from the vehicle 320A, 320B, and up to 320N, respectively. The fuel prediction may be based on the current fuel tank level and total fuel tank capacity of the vehicle 320A, 320B, and up to 320N; based on a previous mileage of the vehicle 320A, 320B, and up to 320N, the current mileage of the vehicle 320A, 320B, and up to 320N, and the fuel efficiency of the vehicle 320A, 320B, and up to 320N; and/or based on other factors included in the data. Similarly, the exhaust prediction may be based on the current exhaust tank level and total exhaust tank capacity of the vehicle 320A, 320B, and up to 320N; based on a previous mileage of the vehicle 320A, 320B, and up to 320N, the current mileage of the vehicle 320A, 320B, and up to 320N, and the exhaust emitted per gallon and fuel efficiency of the vehicle 320A, 320B, and up to 320N; and/or based on other factors included in the data. Once the controller 302 determines the fuel prediction and/or exhaust prediction, the controller 302 may transmit the predictions to the vehicle 320A, 320B, and up to 320N and/or the user device 322A, 322B, and up to 322N. the controller 302 may enable the user to accept, reject, or adjust the prediction, for example, via the user device 322A, 322B, and up to 322N.

Once the user accepts or adjusts the prediction, the controller 302 may execute instructions 314 and/or instructions 318. For example, the controller 302 may initiate the fuel operation in response to reception of acceptance or adjustment of the predicted amount of fuel. The controller 302 may initiate the fueling operation by sending a signal to the corresponding fuel pump 324A, 324B, and up to 324N. In an embodiment, the controller 302 may execute the fueling operation. For example, the controller 302 may control automated components allowing the fuel pump 324A, 324B, and up to 324N to automatically and without user intervention pump fuel to the vehicle 320A, 320B, and up to 320N. In another embodiment, the user or an attendant may utilize (for example, via user intervention or attendant intervention) the fuel pump 324A, 324B, and up to 324N to execute the fuel operation.

The controller 302 may initiate the fueling operation by sending a signal to the corresponding exhaust pump 326A, 326B, and up to 326N. In an embodiment, the controller 302 may execute the exhaust offloading operation. For example, the controller 302 may control automated components allowing the exhaust pump 326A, 326B, and up to 326N to automatically and without user intervention pump exhaust from the vehicle 320A, 320B, and up to 320N. In another embodiment, the user or an attendant may utilize (for example, via user intervention or attendant intervention) the exhaust pump 326A, 326B, and up to 326N to execute the exhaust offloading operation.

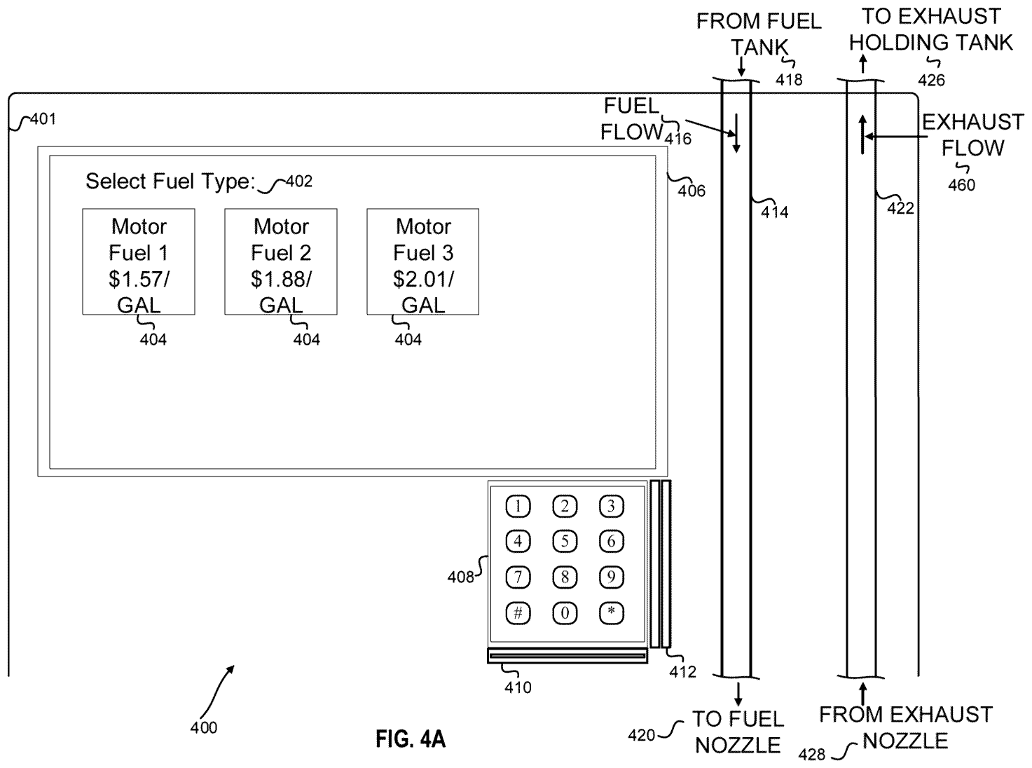

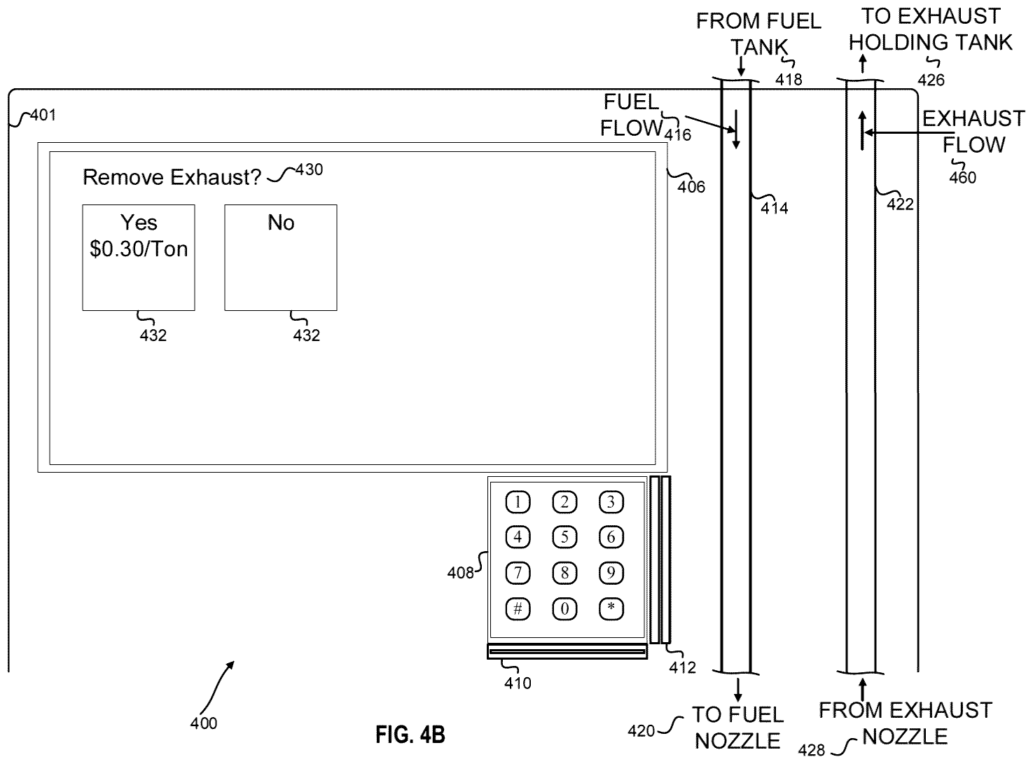

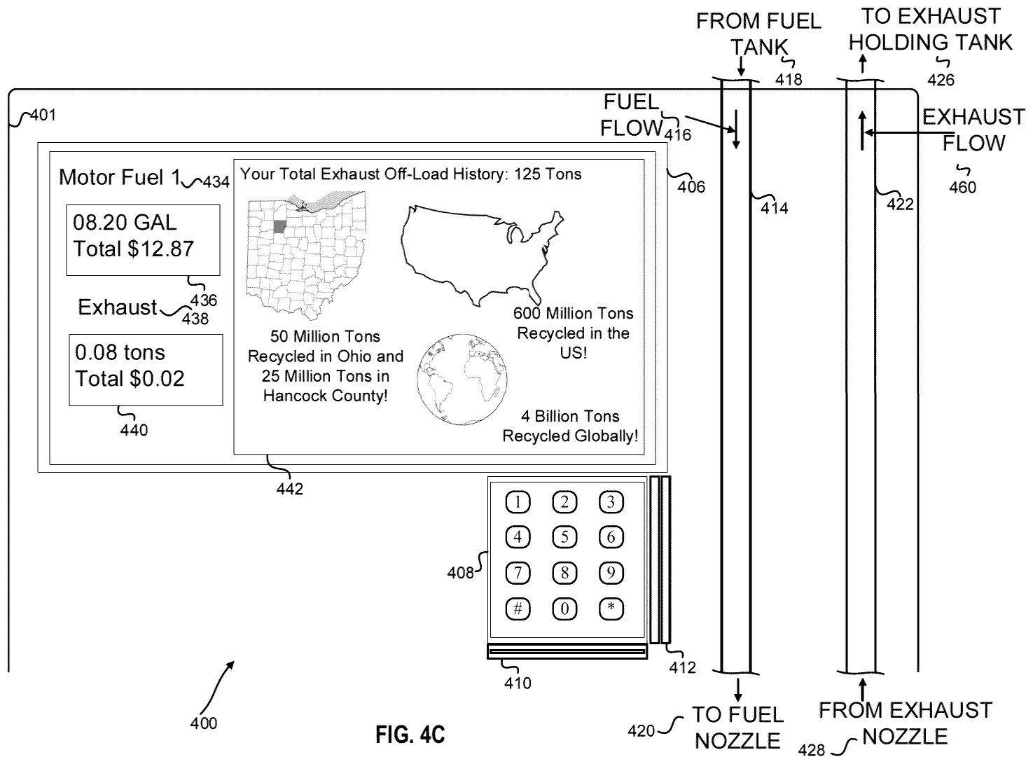

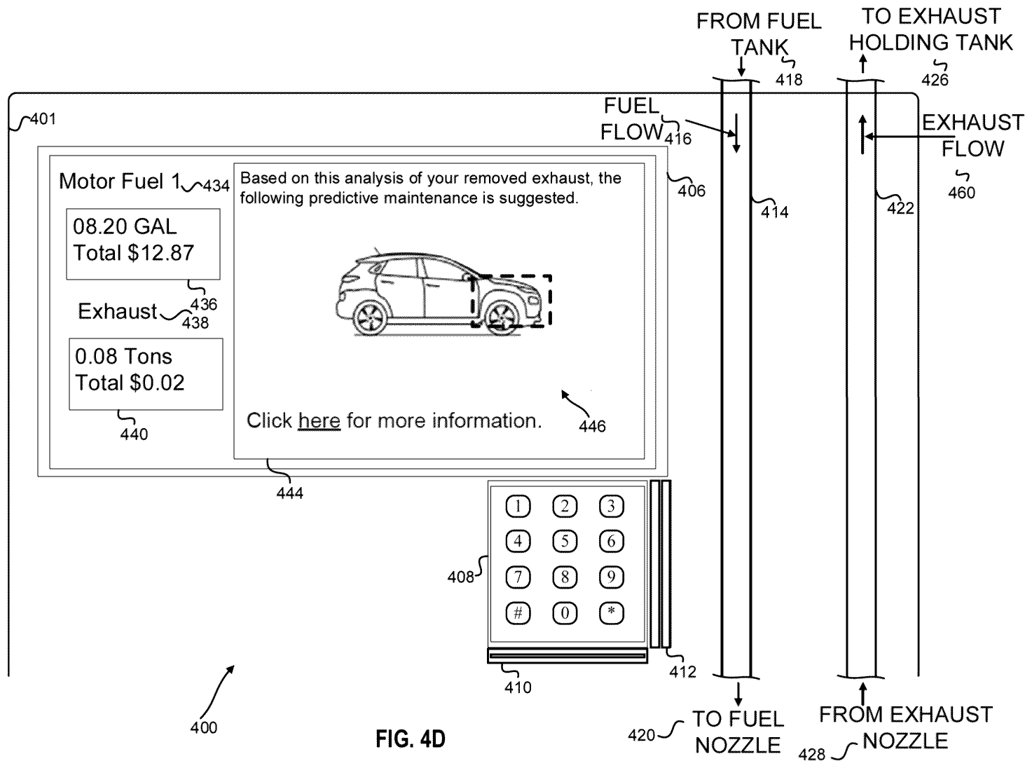

FIG. 4A, FIG. 4B, FIG. 4C, and FIG. 4D are simplified diagrams that illustrate a novel implementation of a fuel and exhaust pump for transporting fuel to a vehicle and offloading exhaust from the vehicle in which the fuel and exhaust pump include two separate nozzles for fuel and for exhaust, and a touchscreen user interface to implement the mobile productivity platform, according to one or more embodiments of the disclosure. In other embodiments, a single hose may be utilized for both operations (for example, exhaust offload and/or fuel pumping). The exhaust hose may be positioned within the fuel hose or the fuel hose may be positioned within the exhaust hose, in such embodiments.

The fuel and exhaust pump 400 may include a user interface 406. The user interface 406 may be disposed on one or both sides of the fuel and exhaust pump 400. The user interface 406 may be a touchscreen or include another input device, such as a mobile or electronic application on a user's device and in signal communication with the fuel and exhaust pump 400. The user interface 406 may be connected to or may be a part of a computing device to predict an amount of fuel to pump to a vehicle and/or exhaust to pump from the vehicle.

As a user begins the operation of fueling and/or offloading exhaust, a computing device within or connected to the fuel and exhaust pump 400 may transmit prompts and/or predictions to the user interface 406 with the prompts and/or predictions being displayed on the user interface 406.

The computing device may prompt (see 402) the user to select a fuel type. A series of selectable buttons 404 may then be displayed on the user interface 406. Each of the series of selectable buttons 404 may include a price associated with a type of fuel. The user may then select a type of fuel. In other examples, an option to skip fuel selection may be displayed on the user interface 406. In yet other examples, options to select fuel and exhaust offload may be displayed together to allow a user to select fuel and/or exhaust offloading simultaneously or substantially simultaneously. The user interface 406 may also include or display other information related to each different type of fuel. For example, the user interface 406 may display the type of fuel, a carbon intensity of the fuel, an origin of the fuel, certifications regarding fuel sustainability, cost of the fuel, and/or any other quantifiable aspects and/or characteristics of the fuel. The carbon intensity of a fuel may be represented by the amount of carbon dioxide by weight per the energy consumed and/or expended to obtain/refine/create/transport the fuel from wellhead to the fuel and exhaust pump 400 and/or the inherent or theoretical carbon dioxide by weight per the energy consumed during future combustion of the fuel. Stated another way, the carbon intensity may represent the amount of carbon dioxide or other greenhouse gases produced at each step of the fuel's lifecycle; scope 1, scope 2, and scope 3 emissions, for example, exploration and production at a wellhead, transporting to a refinery, processing at a refinery, production at a bio-fuel or ethanol plant or facility, transporting to a convenience store or the like, storage, combustion of the fuel, other processes related to the production and/or use of the fuel (for example, the Greenhouse gases, Regulated Emissions, and Energy use in Transportation (GREET) model). In addition to displaying the carbon intensity of a fuel, the user interface 406 may also determine a carbon intensity reduction based on an amount of exhaust or carbon dioxide pumped from a vehicle. For example, if a user selects a particular fuel at a particular carbon intensity and then pumps an amount of exhaust or carbon dioxide via the fuel and exhaust pump 400, the user interface 406 may display the net carbon intensity, for example, the carbon intensity of the fuel reduced by the amount of carbon dioxide captured by the user during transportation. The carbon intensity measured for particular vehicles may be used as a metric to compare to other options of transportation, for example, internal combustion engine vehicle as compared with a battery electric vehicle or as compared to a hydrogen fuel cell or hydrogen fueled vehicle.

After selection of a fuel or if the user skips fuel selection, the computing device may generate a prompt 430, to display on the user interface 406, for the user to select whether to remove captured exhaust or carbon dioxide from the vehicle or the on-board exhaust capture device of the vehicle. The user interface 406 may display a series of selectable pop-up buttons 432, including the option of whether to offload exhaust or not and a potential cost associated with offloading the exhaust. In an embodiment, offloading exhaust may not include a cost, but a savings. In another embodiment, offloading exhaust may include a fee or nominal cost, but also include an incentive, such as free goods and/or services, discounts on goods and/or services, and/or a discount on fuel. In yet another embodiment, a user may be compensated for offloading exhaust and the user interface 406 may indicate the amount a user may be compensated for a certain amount or quantity of exhaust.

In an embodiment, the computing device may generate a prediction based on one or more detected characteristics of the vehicle. The computing device may detect such characteristics via a detector disposed or positioned on the fuel and exhaust pump 400 and/or on a bay associated with the fuel and exhaust pump 400. Based on these characteristics, the computing device may determine and then display on the user interface 406 an amount of fuel for the vehicle and/or an amount of exhaust to offload from the vehicle. Further, the user interface 406 may include an option to adjust such predictions and/or reject the prediction.

After selecting a fuel and/or selecting whether to offload exhaust, the user may be prompted to transact payment for the selected fuel and/or exhaust offloading operation. In an embodiment, the user interface 406 may include options to pay, for example, via entering a username and credentials for a payment account. In another embodiment the fuel and exhaust pump 400 may include a keypad 408, chip reader 410, and/or magnetic strip reader 412. The user interface 406 may then include a prompt to effectuate payment. In another embodiment, the computing device, upon detection of the vehicle, may associate the vehicle with a particular user and/or user account. Payment for the operations may occur automatically or substantially automatically based on payment methods associated with the user and/or user account. The user interface 406 may include an option to accept the associated payment method, prior to completing the transaction.

Once a payment has been made, the user interface 406 may prompt the user, if the selection to fuel the vehicle has been made by the user, to insert a fuel nozzle (see 420) into a corresponding fuel port of a vehicle and to insert an exhaust nozzle (see 428) into a corresponding exhaust port of a vehicle, if the selection to offload exhaust from the vehicle has been made by the user. The fuel nozzle (see 420) may be in fluid communication with a fuel pipe 414 and the fuel pipe 414 may be in fluid communication with a fuel tank (see 418). Fuel may flow, for example, fuel flow 416, from the fuel tank (see 418) through the fuel pipe 414 and to the fuel nozzle (see 420), and thus to the vehicle. The exhaust nozzle (see 428) may be in fluid communication with an exhaust pipe 422 and the exhaust pipe 422 may be in fluid communication with an exhaust holding tank (see 428). Exhaust may flow, for example, exhaust flow 460, from the on-board exhaust capture device of the vehicle to the exhaust nozzle (see 428) through the exhaust pipe 422 and to the exhaust holding tank (see 426). In an embodiment, the fuel and exhaust pump 400 may prevent pumping of exhaust until it is determined that the exhaust nozzle (see 428) is sealingly engaged with the corresponding exhaust port of the vehicle.

In an embodiment, the fuel and exhaust pump 400 may include meters, sensors, and/or analyzers. The meters, sensors, and/or analyzers may be positioned upstream of the fuel nozzle (see 420) and/or downstream of the exhaust nozzle (see 428). The meters may be positioned to measure an amount of fuel and/or exhaust, in relation to fuel flowing through the fuel pipe 414 and in relation to exhaust flowing through the exhaust pipe 422, respectively. As the fuel is pumped to the vehicle, the fuel meter may transmit an amount, for example, volume, of fuel to the user interface 406 or a computing device in signal communication with the user interface 406. A rolling or continuously updating total 436, for example, a total increasing as fuel is pumped, may be displayed, along with an associated cost, on the user interface 406. The type of selected fuel 434 may be identified on the user interface 406. As the exhaust is pumped from the vehicle, the exhaust meter may transmit an amount of exhaust to the user interface 406 or a computing device in signal communication with the user interface 406. A rolling or continuously updating total 440, for example, a total increasing as exhaust is pumped from the vehicle, may be displayed, along with an associated cost or payment, on the user interface. The flow of exhaust 438 may be identified on the user interface 406. In another embodiment, the rolling or continuously updating total 440 may count down from a total amount of exhaust in the vehicle as such total amount may be measured, calculated, or estimated. In a further embodiment, the rolling or continuously updating total 440 may include a time until the amount of exhaust is completely offloaded. In such embodiments, the amount of exhaust stored on a vehicle may be determined by the computing device via connections to the vehicle through pins or input/outputs on the exhaust nozzle (see 428). The pins or input/outputs may correspond to pins or inputs/outputs on a vehicle's exhaust port. Data, including the amount of exhaust stored in a vehicle, may be transferred from the vehicle to the fuel and exhaust pump 400 via the pins or inputs/outputs. In such examples, the data may be utilized to determine an amount of exhaust to offload and, based on that amount, estimate or determine the time to offload the exhaust. In another embodiment, the corresponding pins or inputs/outputs of the vehicle may connect to an on-board diagnostic module of the vehicle. The on-board diagnostic module may include an amount of exhaust currently captured by the vehicle based on factors, such as, the amount of fuel consumed by an internal combustion engine and the exhaust flow.

Measurements of the flow rate or amount of exhaust flowing from the vehicle may be stored in the non-transitory machine readable storage medium or memory of a computing device associated with a convenience store that is in signal communication with the fuel and exhaust pump 400 at that location, or of a computing device external to the convenience store (for example, off-site or remote therefrom) that is in signal communication with the fuel and exhaust pump 400. Data relating to exhaust offloading may be accumulated over a period of time or until the exhaust is picked up by a delivery vehicle. The data may be included in a report. The report may be generated by a computing device internal or external to the convenience store or wherever the fuel and exhaust pump 400 may be located. The report may be in a format suitable for environmental reports to be sent to local, state, and or federal government agencies. The data may also be listed or displayed on the user interface 406. The data may be displayed as an exhaust offload history for a particular user, a local exhaust offload history (for example, city, town, and/or county), a state offload exhaust history, a country-wide exhaust offload history, and/or global exhaust offload history as illustrated by portion 442 of the user interface 406.

In another embodiment, an analyzer may be disposed at a point between the exhaust nozzle (see 428) and exhaust holding tank (see 426). The analyzer may obtain or receive a sample of the exhaust. The analyzer may determine, via predictive analytics, machine learning, and/or artificial intelligence, the composition of the sample. The analyzer may send the composition of the exhaust to the computing device for storage, for reporting, or for display on the user interface 406. The user interface 406 may display the composition of the exhaust. The computing device may determine, based on the composition of the exhaust, whether a vehicle may be ready for or in need of service or preventative maintenance and/or types of services for the vehicle. The computing device may determine that the vehicle may require servicing or maintenance. The user interface 406 may display the suggestion or determination. Based on differing amounts of different chemicals, or purity, in the exhaust, the computing device may determine potential issues with the vehicle, the on-board vehicle exhaust capture device, or the thermal efficiency of the vehicle. For example, if the exhaust includes high amounts of unburned fuel, then the computing device may determine that the vehicles engine may be experiencing issues. In another example, the computing device may determine, based on higher than typical amounts of nitric oxides in exhaust, that an issue exists with a catalytic converter.

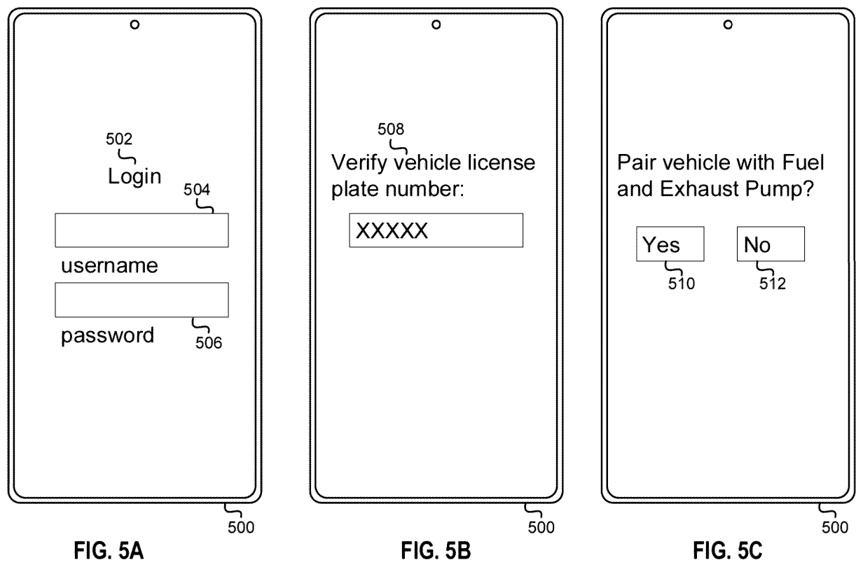

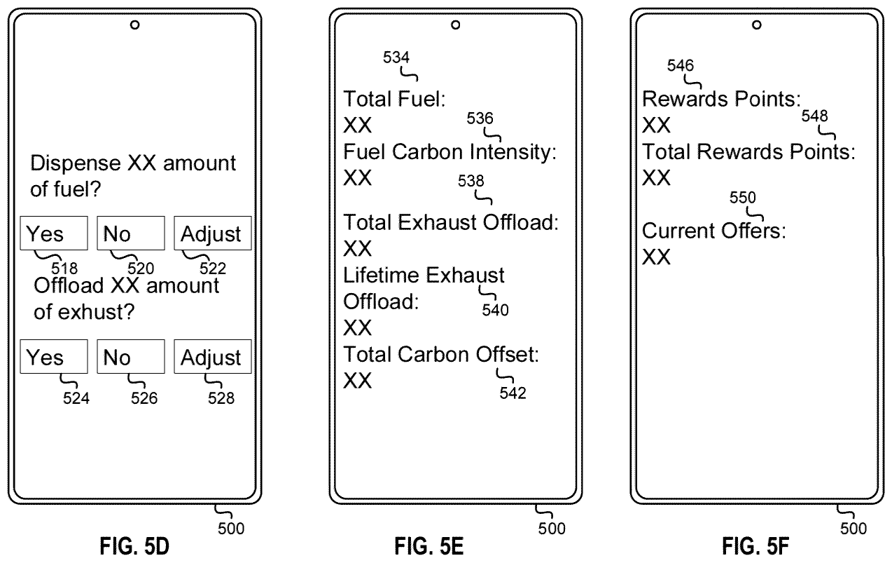

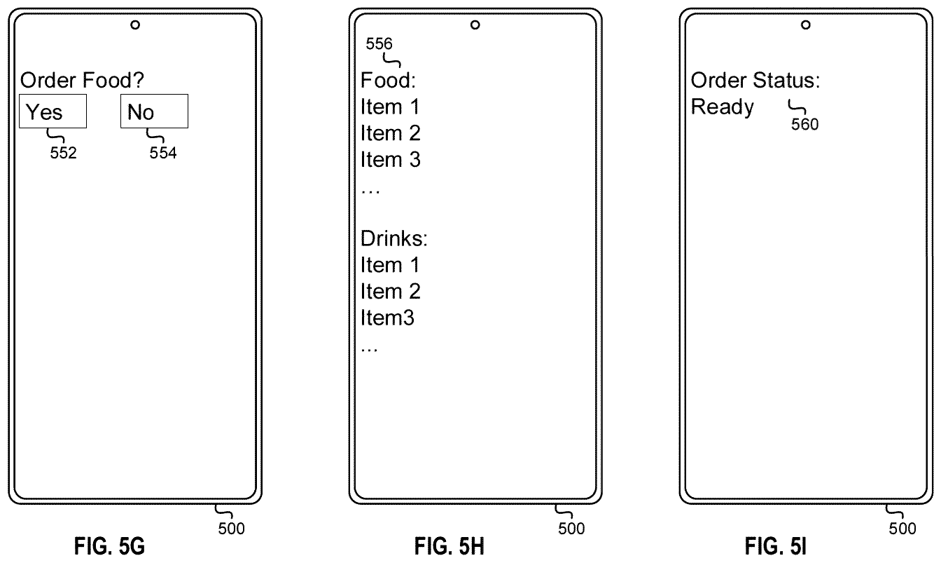

FIG. 5A, FIG. 5B, FIG. 5C, FIG. 5D, FIG. 5E, FIG. 5F, FIG. 5G, FIG. 5H, and FIG. 5I are simplified diagrams illustrating, at least a part, of the mobile productivity platform on a user device 500. As noted, the computing device may generate, at least in part, a user interface for a user device 500. The user device 500 may be a mobile device and/or a device positioned within the vehicle (for example, an interactive dashboard). In FIG. 5A, the user interface may include a login 502 for a particular user. The user may log into the interface at any time (for example, prior, after, or during detection or discovery of the vehicle at a station) by entering a username 504 and password 506. In an embodiment, a registration link may be included in the user interface to enable new users to register to enable use of the mobile production platform.

At FIG. 5B, upon detection or discovery of a vehicle by a detector and/or computing device, the computing device may transmit the vehicle's license plate number 508 to the user device 500. The user device 500 may display, via the user interface, the vehicle's license plate number 508 and/or other identifier for user verification. In other words, the user interface may request that a user verify the license plate and/or other identifier prior to proceeding to subsequent operations. In an embodiment, upon user verification, as illustrated in FIG. 5C, the user interface may request that the user pair the user device with a fuel and exhaust pump (for example, including buttons yes 510 and no 512). In another embodiment, such pairing may occur automatically.

As illustrated in FIG. 5D, a prediction for a fuel amount and exhaust amount, determined by the computing device and based on various aspects and characteristics of the vehicle, may be displayed for acceptance, rejection, or adjustment. For example, a computing device may determine or predict that a specified amount of gallons of fuel may be pumped to a vehicle (based on a number of factors as described herein). The computing device may display such an amount on the user interface, via the user device 500, along with a request to accept (for example, yes 518), reject (for example, no 520), or adjust (for example, adjust 522). In such embodiments, selecting adjust 522 may cause the user interface to allow a user to change the specified amount of fuel. A computing device may determine or predict that a specified amount of exhaust to be pumped from a vehicle (based on a number of factors as described herein). The computing device may display such an amount on the user interface, via the user device 500, along with a request to accept (for example, yes 524), reject (for example, no 526), or adjust (for example, adjust 528). In such embodiments, selecting adjust 528 may cause the user interface to allow a user to change the specified amount of exhaust.

As illustrated in FIG. 5E, after or during fueling and exhaust offload operations, specified metrics may be displayed or tallied (for example, the value may be a rolling value based on the fuel or exhaust transfer currently occurring). For example, the user interface may include total amount of fuel pumped for an operation (see 534), a fuel carbon intensity (see 536) as determined by the computing device, a total exhaust offload (see 540) for the current exhaust offload operation, a lifetime exhaust offload (see 540) for a corresponding vehicle and/or user, and/or a total carbon offset (see 542) for the current operations and/or over the lifetime of the vehicle and/or user as determined by the computing device.

Further, such operations may include providing rewards to a user based on fuel and/or exhaust operations. As illustrated in FIG. 5F, the user interface may display the rewards points for the current transaction (see 546), the current total amount of rewards points held by the user (see 548), and any current offers for the user (see 550, for example, free or discounted goods and/or services).

The user interface may also allow a user to order goods and/or services prior to, during, or after fueling and/or exhaust offload operations. For example, in FIG. 5G, the user interface may prompt a user to order food during fueling and/or exhaust offload. The user may choose to order food (see ‘yes’ 552) or not (see ‘no’ 554). If the user chooses to order food, an interactive menu may be displayed including a number of choices, see 556 as illustrated in FIG. 5H. While the user waits for the fueling and/or exhaust offloading operation to finish, the user may be able to check their order status (see 560), as illustrated in FIG. 5I.

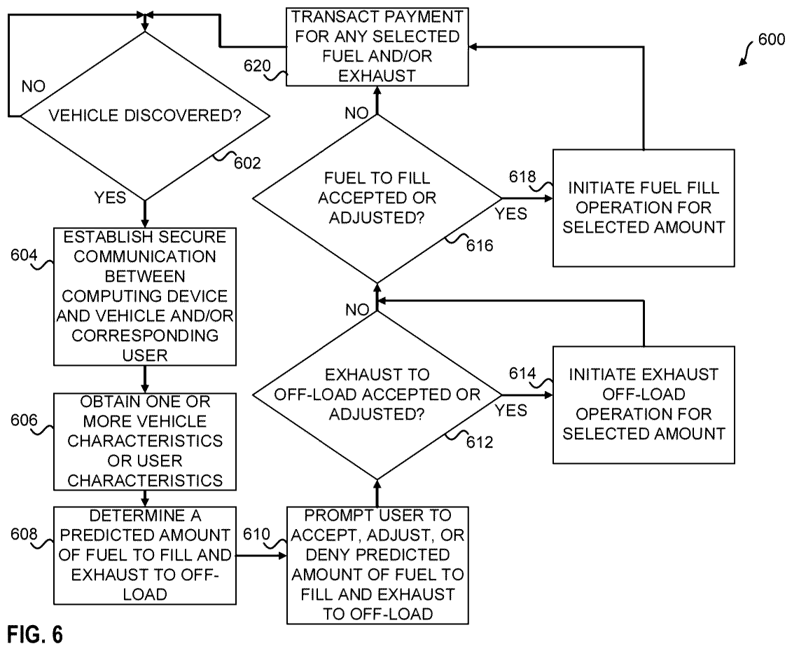

FIG. 6 is a flow chart illustrating utilization of a mobile productivity platform, according to one or more embodiments of the disclosure. The components of FIGS. 1 through 5I and 7A through 8 may utilize such a method. In an embodiment, the actions of method 600 may be completed within the computing device 300. Specifically, method 600 may be included in one or more programs, protocols, or instructions loaded into memory of a computing device of or separate from the fuel and exhaust pump 400 or memory of the fuel and exhaust pump 400. The order in which the operations are described is not intended to be construed as a limitation, and any number of the described blocks may be combined in any order and/or in parallel to implement the disclosed methods.

At block 602, a computing device may determine whether a vehicle is detected or discovered. The computing device may scan for vehicles continuously, substantially continuously, or periodically. The computing device may use one or more different components to scan for various different aspects and/or characteristics of the vehicle. For example, the computing device may utilize one or more sensors, one or more image capture devices, and/or one or more transmitters/receivers. Such components may be included in a detector and/or the computing device. If a vehicle has not been detected or discovered, the computing device may wait prior to proceeding to the next operation.

At block 604, the computing device may establish secure communication between the computing device and the vehicle and/or a corresponding user device or interface. The secure communication may ensure that data transmitted to the computing device form the vehicle and/or a user device is not intercepted or exploited by an external third party. In another embodiment, the vehicle and/or user device may encrypt the data prior to transmission to the computing device.

At block 606, the computing device may obtain one or more vehicle characteristic and/or user characteristics. For example, the computing device may obtain fuel tank total capacity, a fuel tank level, exhaust tank total capacity, exhaust tank level, miles per gallon or fuel efficiency, exhaust emitted per gallon, mileage of the vehicle, diagnostic data, data related to other aspects and/or characteristics of the vehicle, fuel transaction history, exhaust transaction history, a last station or site visited, transaction data related to the last station or site visited, goods and/or service purchase or order history, and/or user account information.

At block 608, the computing device may determine a predicted amount of fuel to fill and exhaust to offload to/from the vehicle based the received data. At block 610, the computing device may prompt a user to accept, adjust, or deny or reject the predicted amount of fuel to fill and exhaust to offload to/from the vehicle (for example, via the user device and/or a fuel and exhaust pump).

At block 612, the computing device may determine whether the exhaust amount was accepted or adjusted by the user. If the amount was rejected, the computing device may move to block 616, otherwise, at block 614, the computing device may initiate exhaust offload operations for the selected amount of exhaust to offload from the vehicle.

At block 616, the computing device may determine whether the fuel amount was accepted or adjusted by the user. If the amount was rejected, the computing device may move to block 620, otherwise, at block 618, the computing device may initiate fueling operations for the selected amount of exhaust to offload from the vehicle. At block 620, the computing device may transact payment for the fuel and/or exhaust (for example, for example via the user device and/or a fuel and exhaust pump).

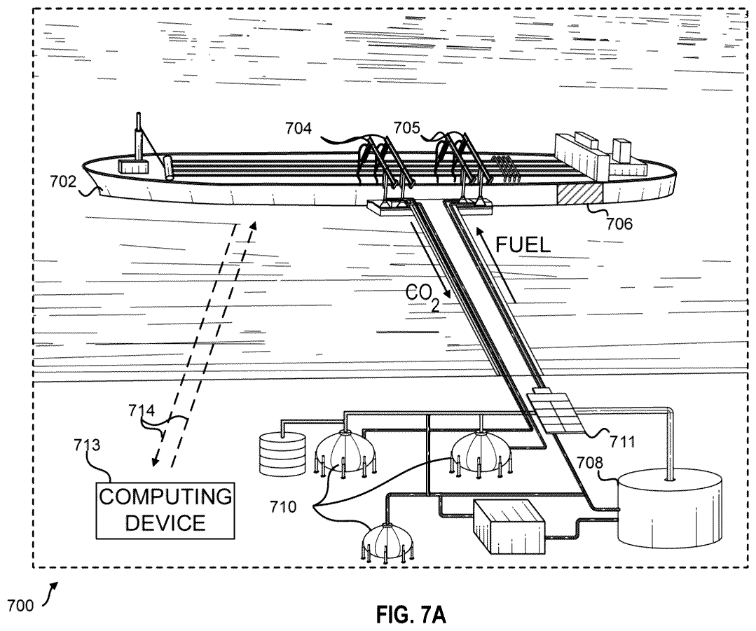

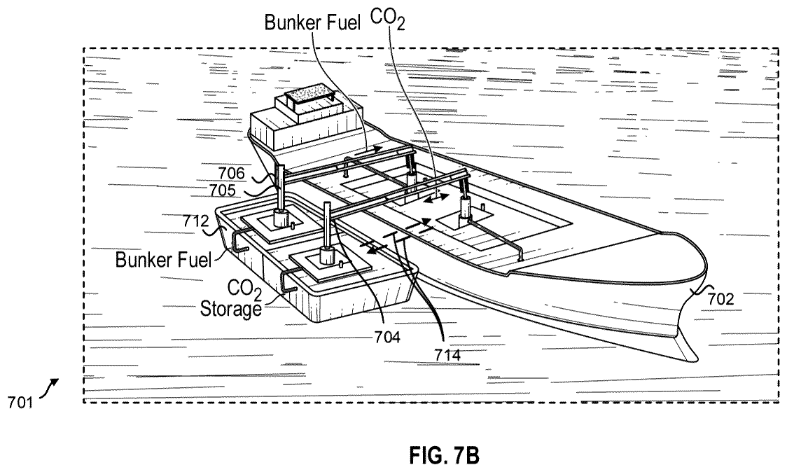

As noted, a scalable greenhouse capture system may be utilized for a variety of vehicles, for example, a marine vessel 702. FIG. 7A and FIG. 7B are schematic diagrams that illustrate scalable greenhouse gas capture systems 700 for offloading captured exhaust, greenhouse gases, or carbon dioxide from a marine vessel 702, according to one or more embodiments of the disclosure. The marine vessel 702 may include an exhaust or carbon capture device. The exhaust or carbon capture device may capture carbon dioxide and/or other chemicals/greenhouse gases produced by the engine of the marine vessel 702 and/or from the air. The captured exhaust or carbon dioxide may be stored, as a liquid or a gas, in a storage section 706 or tank of the marine vessel 702. The marine vessel 702 may re-fuel at a seaport, at an on-shore dock, or an off-shore platform/dock as illustrated in FIG. 7A, or off-shore bunkering via a smaller marine vessel 714 or tugboat with a fueling and/or exhaust/greenhouse gas vessel 712. The seaport or dock may include several armatures 704, 705. Each of the armatures 704, 705 may include a distal end and proximal end. A swivel joint may connect the proximal end to of the armatures 704, 705 to a pipeline. The pipeline may connect to a pump. Another pipeline may connect the pump to a meter and/or sampler/analyzer. The meter and/or analyzer may connect directly to an exhaust or greenhouse gas holding vessel 710 or tank, to an additional compressor or pump, or to a manifold 711. The manifold 711 may include several connections or pipelines to different tanks, spheres, or other components. The distal end of the armatures 704, 705 may connect to a corresponding port on the marine vessel 702. Upon connection of the distal end to the port of the marine vessel 702, the exhaust or greenhouse gas may be pumped from a tank of the marine vessel 702. A pump connected to the armature 704 may pump the exhaust or greenhouse through the armature 704. The exhaust may flow through the swivel joint to the meter and/or sampler/analyzer. The exhaust may further flow through to the additional compressor or pump, for further compression the exhaust or greenhouse gas. The exhaust or greenhouse gas may further flow to the holding tank. The armatures may include additional pumps to allow for pumping of the exhaust to the marine vessel 702 for shipment. The marine vessel 702 may be a blue water vessel, for example, a deep sea vessel, or a brown water vessel, for example, an inland or coastal waterway vessel, such as a tow or barge. In another embodiment, the seaport or dock may include fuel armatures 1305 connected to a fuel storage tank 708 for providing fuel to the marine vessel 702.

As illustrated in FIG. 7B, the marine vessel 702 may re-fuel or offload stored exhaust or greenhouse gases off-shore. A smaller marine vessel or tug boat may haul or transport a floating fuel and exhaust or greenhouse gas storage vessel 710. Such a vessel may be constructed similar to the fuel tank and/or exhaust or greenhouse gas storage tank of the marine vessel. The vessel may dock at the seaport or dock to offload exhaust, for example, at the seaport as illustrated in FIG. 7A.

The mobile productivity platform may be utilized in such embodiments. The mobile productivity platform may include a display or device onboard the marine vessel. The display and/or device may connect to an on-shore computing device 713. The on-shore computing device 713 may determine or predict an amount of fuel to fill and exhaust to offload from the marine vessel 702. The on-shore computing device 713 may detect and connect to the marine vessel 702 when the marine vessel 702 docks. The on-shore computing device 713 may utilize various marine vessel 702 characteristics to determine such amounts, such as the amount of fuel stored in the marine vessel 702, the amount of exhaust in the marine vessel 702, among other factors. The on-shore computing device 713 may, after making such predictions, send or transmit a request to accept, deny, or adjust the amount of fuel and/or exhaust. Upon acceptance or adjustment, the on-shore computing device 713 may initiate the fueling and/or exhaust offloading operations.

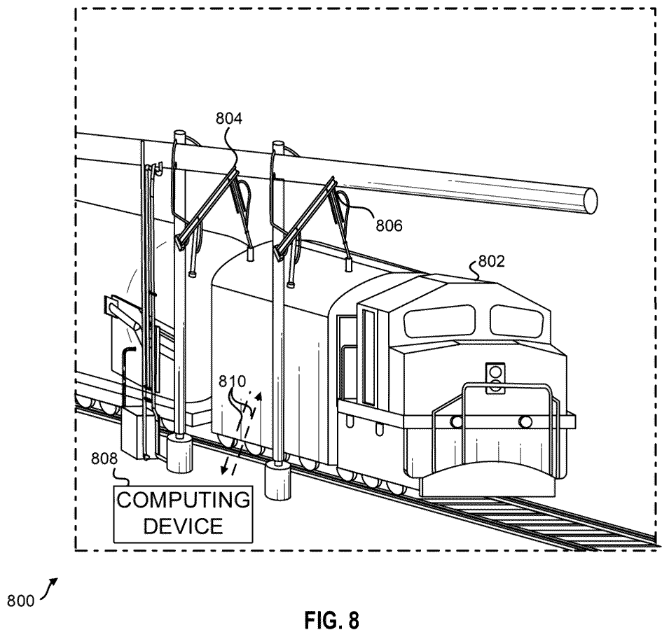

FIG. 8 is a schematic diagram that illustrates scalable greenhouse gas capture systems for offloading captured greenhouse gas from a locomotive and/or rail car to a greenhouse gas holding tank and transporting the greenhouse gas from the greenhouse gas holding tank, via a transportation mechanism, for re-use, recycle, or permanent storage, according to one or more embodiments of the disclosure. The locomotive and/or rail cars 802 may include an exhaust or carbon capture device to capture exhaust, carbon dioxide, carbon dioxide from the air, and/or some other gases/chemicals. The exhaust or carbon dioxide may be produced via an internal combustion engine of the locomotive and/or rail cars 802. The locomotive and/or rail cars 802 may re-fuel at a rail fueling station, as illustrated in FIG. 8. The rail fueling station may include several armatures 804, 806. The armatures 804, 806 may include a distal end and proximal end. A swivel joint may connect the proximal end to a pipeline. The pipeline may connect to a pump. Another pipeline may connect the pump to a meter and/or sampler/analyzer. The meter and/or analyzer may connect directly to an exhaust or greenhouse gas holding tank or to an additional compressor or pump. The distal end may connect to a corresponding port on the locomotive and/or rail cars 802. Upon connection of the distal end to the port of the locomotive and/or rail cars 802, the exhaust or greenhouse gas may flow from a tank of the locomotive and/or rail cars 802. A pump connected to the armature 804, 806 may pump the exhaust or greenhouse through the armature 804, 806. The exhaust may flow through the swivel joint to the meter and/or sampler/analyzer. The exhaust may further flow through the additional compressor or pump, to further compress the exhaust or greenhouse gas. The exhaust or greenhouse gas may further flow to the holding tank.

In another embodiment, the locomotive and/or rail cars 802 may include a storage section or storage cart, connected to the locomotive and/or rail cars 802. The storage section or storage cart may store exhaust, greenhouse gases, or carbon dioxide captured by the exhaust or carbon capture device of the locomotive and/or rail cars 802. In another embodiment, the storage section or storage cart may store exhaust, greenhouse gases, or carbon dioxide for transport for further use. In such embodiments, the armatures 804, 806 may additionally be configured to pump exhaust, greenhouse gases, or carbon dioxide to the storage section or storage cart.

The mobile productivity platform may be utilized in such embodiments. The mobile productivity platform may include a display or device onboard the locomotive and/or rail cars 802. The display and/or device may connect to a computing device 808. The computing device 808 may determine or predict an amount of fuel to fill and exhaust to offload from the locomotive and/or rail cars 802. The computing device 808 may detect and connect to the locomotive and/or rail cars 802 when the locomotive and/or rail cars 802 docks. The computing device 808 may utilize various locomotive and/or rail cars 802 characteristics to determine such amounts, such as the amount of fuel stored in the locomotive and/or rail cars 802, the amount of exhaust in the locomotive and/or rail cars 802, among other factors. The computing device 808 may, after making such predictions, send or transmit a request to accept, deny, or adjust the amount of fuel and/or exhaust. Upon acceptance or adjustment, the computing device 808 may initiate the fueling and/or exhaust offloading operations.

This application claims priority to, and the benefit of U.S. Provisional Application No. 63/384,663, filed Nov. 22, 2022, titled “SYSTEMS AND METHODS FOR A MOBILE PRODUCTIVITY PLATFORM,” the disclosure of which is incorporated herein by reference in its entirety.

In the drawings and specification, several embodiments of systems and methods to provide scalable greenhouse gas capture have been disclosed, and although specific terms are employed, the terms are used in a descriptive sense only and not for purposes of limitation. Embodiments of systems and methods have been described in considerable detail with specific reference to the illustrated embodiments. However, it will be apparent that various modifications and changes may be made within the spirit and scope of the embodiments of systems and methods as described in the foregoing specification, and such modifications and changes are to be considered equivalents and part of this disclosure.

What is claimed is:

1. A system to provide a mobile productivity platform controller to determine an amount of fuel for a vehicle and to determine an amount of captured exhaust to offload from a vehicle, the system comprising:
a bay including:
a fuel dispenser,
an exhaust receiver, and
a detector configured to (a) determine whether the vehicle is approaching the bay and (b) in response to a determination that the vehicle is approaching the bay, obtain data associated with the vehicle and data associated with a user of the vehicle; and
a mobile productivity platform controller in signal communication with the detector, the mobile productivity platform controller configured to:
receive the data associated with the vehicle and data associated with the user of the vehicle from the detector,
determine a predicted amount of fuel to pump to the vehicle based on the data associated with the vehicle and data associated with the user of the vehicle from the detector,
determine a predicted amount of exhaust to offload from the vehicle based on the data associated with the vehicle and data associated with the user of the vehicle from the detector, and
in response to a selection of one or more of an amount of fuel based on the predicted amount of fuel and an amount of exhaust based on the predicted amount of exhaust, initiate one or more of (a) a fueling operation for the amount of fuel via the fuel dispenser or (b) an exhaust offloading operation for the amount of exhaust via the exhaust receiver.

2. The system of claim 1, wherein one or more of the fueling operation or exhaust offloading operation occurs automatically, via user intervention, or via an attendant's intervention.

3. The system of claim 1, wherein the detector is configured to (a) determine whether one or more of a Wi-Fi signal, a RFID signal, a NFC signal, a cellular signal, a Bluetooth signal, or other signal emanates from the vehicle and (b) obtain data therefrom.

4. The system of claim 3, wherein the detector comprises one or more of an image capture device configured to capture an image of a specified portion of the vehicle or a geolocation device to obtain coordinates associated with a location of the vehicle.

5. The system of claim 1, wherein the mobile productivity platform controller is in signal communication with a device corresponding to the user and is further configured to:
generate a display for a user interface of the device including a selectable and adjustable amount of fuel based on the predicted amount of fuel and a selectable and adjustable amount of exhaust based on the predicted amount of exhaust.

6. The system of claim 5, wherein the selection of one or more the amount of fuel and the amount of exhaust is based on selections via the display.

7. The system of claim 6, wherein the data associated with the vehicle comprises one or more of a fuel tank total capacity, a fuel tank level, exhaust tank total capacity, exhaust tank level, miles per gallon or fuel efficiency, exhaust emitted per gallon, mileage of the vehicle, diagnostic data, or data related to other characteristics of the vehicle.

8. The system of claim 7, wherein the data associated with the user of the vehicle comprises fuel transaction history, exhaust transaction history, a last station visited, transaction data related to the last station visited, or account information and wherein the data associated with the vehicle further includes mileage of the vehicle at the last station visited.

9. The system of claim 8, wherein the mobile productivity platform controller determines the predicted amount of fuel based on (a) the fuel tank level; (b) the fuel tank total capacity, miles per gallon or fuel efficiency, mileage of the vehicle, and mileage of the vehicle at the last station visited; (c) fuel transaction history; or (d) a combination thereof.

10. The system of claim 9, wherein the mobile productivity platform controller determines the predicted amount of fuel based on (a) the exhaust tank level; (b) the exhaust tank total capacity, exhaust emitted per gallon, mileage of the vehicle, and mileage of the vehicle at the last station visited; (c) exhaust transaction history; or (d) a combination thereof.

11. The system of claim 8, wherein the mobile productivity platform controller is configured to:
determine types of services for the vehicle based on the data associated with the vehicle and data associated with the user of the vehicle; and
transmit the types of services for the vehicle to the device.

12. The system of claim 5, wherein the device comprises a user device, a smart phone, a tablet, a vehicle user interface, or some combination thereof.

13. The system of claim 1, wherein the exhaust receiver is configured to analyze offloaded exhaust.

14. The system of claim 13, wherein the mobile productivity platform controller is configured to:
determine types of services for the vehicle based on analyzed offloaded exhaust; and
transmit the types of services for the vehicle to the device.

15. The system of claim 1, wherein the bay further comprises a canopy, and wherein the detector is positioned on the canopy.

16. The system of claim 1, wherein the bay further comprises a canopy, wherein the detector comprises one or more detection devices, and wherein each of the one or more detection devices are positioned on one or more of the canopy, the fuel dispenser, the exhaust receiver, proximate to the bay, or at a specified distance from the bay.

17. A system to provide a determined amount of fuel for a vehicle and a determined amount of captured exhaust to offload from a vehicle, the system comprising:
a bay including:
a fuel dispenser,
an exhaust receiver, and
a detector configured to (a) determine if the vehicle is approaching the bay and (b) in response to determination that the vehicle is approaching the bay, obtain data associated with the vehicle and data associated with a user of the vehicle; and
a controller in signal communication with the detector, the controller configured to:
receive the data associated with the vehicle and data associated with the user of the vehicle from the detector,
prompt the user to select an amount of fuel, from an initial amount of fuel based on one or more of the data associated with the vehicle or data associated with the user of the vehicle from the detector, for the vehicle and to select an amount of exhaust, from an initial amount of exhaust based on one or more of the data associated with the vehicle or data associated with the user of the vehicle from the detector, to offload from the vehicle, and
in response to a selection of one or more of the amount of fuel or the amount of exhaust, initiating one or more, initiate one or more of (a) a fueling operation for the amount of fuel via the fuel dispenser or (b) an exhaust offloading operation for the amount of exhaust via the exhaust receiver.

18. The system of claim 17, wherein one or more of the controller, the vehicle, a user device, the fuel dispenser, the exhaust receiver, or the detector are configured to determine the initial amount of fuel and the initial amount of exhaust based on one or more of the data associated with the vehicle or data associated with the user of the vehicle.

19. The system of claim 17, wherein the bay further includes the computing device, and wherein the computing device includes the detector.

20. A method to provide a determined amount of fuel for a vehicle and a determined amount of captured exhaust to offload from the vehicle, the method comprising:
determining, via a detector of a fuel and exhaust dispenser/receiver controller positioned proximate to one or more or fuel dispensers or exhaust receivers, a position of a vehicle; and
in response to an indication based on a signal from the detector that the vehicle is positioned adjacent to one or more of the fuel dispensers or exhaust receivers:
establishing a secure communication channel between the fuel and exhaust dispenser/receiver controller and the vehicle,
obtaining, by the detector via the secure communication channel, one or more of fuel tank characteristics or exhaust tank characteristics,
determining one or more of an amount of fuel to fill a fuel tank or an amount of exhaust to empty an exhaust tank based on one or more of the fuel tank characteristics or exhaust tank characteristics
prompting, by the fuel and exhaust dispenser/receiver controller, the vehicle to accept, adjust, or deny (a) the amount of fuel to fill the fuel tank or (b) the amount of exhaust to empty the exhaust tank, and
in response to selection by the vehicle (a) to accept an amount of fuel or (b) to offload an amount of exhaust, initiating one or more corresponding fueling operations or exhaust offloading operations.

21. The method of claim 20, wherein the fuel tank characteristics include a fuel tank level and the exhaust tank characteristics include an exhaust tank level.

22. The method of claim 20, wherein a corresponding fuel operation includes pumping the amount of fuel to the vehicle, and wherein a corresponding exhaust offloading operation includes pumping the amount of exhaust captured by an onboard capture device of the vehicle.

23. A method to provide a determined amount of fuel for a vehicle and a determined amount of captured exhaust to offload from the vehicle, the method comprising:
determining, via a detector of a fuel and exhaust dispenser/receiver controller positioned in each one of one or more or fuel dispensers or exhaust receivers, a position of the vehicle; and
in response to an indication based on a signal from the detector that the vehicle is positioned adjacent to a corresponding one of the one or more fuel dispensers or exhaust receivers:
establishing a secure communication channel between the fuel and exhaust dispenser/receiver controller and the vehicle,
obtaining, by the detector via the secure communication channel, one or more of fuel tank characteristics or exhaust tank characteristics,
determining one or more of an amount of fuel to fill a fuel tank or an amount of exhaust to empty an exhaust tank based on one or more of the fuel tank characteristics or exhaust tank characteristics
prompting, by the fuel and exhaust dispenser/receiver controller, the vehicle to accept, adjust, or deny (1) the amount of fuel to fill the fuel tank or (2) the amount of exhaust to empty the exhaust tank, and
in response to selection by the vehicle (1) to accept an amount of fuel or (2) to offload an amount of exhaust, initiating one or more corresponding fueling operations or exhaust offloading operations.

24. The method of claim 23, wherein each of the fuel dispensers and exhaust receivers includes a fuel and exhaust point of sales device, and wherein the fuel and exhaust point of sales system includes the fuel and exhaust dispenser/receiver controller.

25. The method of claim 24, wherein the fuel and exhaust point of sales system includes a user interface configured to display prompts and transactions.

26. A method to provide a determined amount of fuel for a vehicle and a determined amount of captured exhaust to offload from a vehicle, the method comprising:
in response to arrival of a vehicle at a bay, obtaining vehicle data from the vehicle;
determining a fuel tank level and an exhaust tank level based on the vehicle data;
determining a user history based on user data associated with the vehicle;
prompting a user to proceed with one or more of a fuel operation or an exhaust offload operation based on the fuel tank level and the exhaust tank level;
in response to acceptance of the fuel operation, initiating the fuel operation; and
in response to acceptance of the exhaust offload operation, initiating the exhaust offload operation.

27. The method of claim 26, further comprising:
subsequent to completion of the fuel operation and exhaust offload operation, requesting payment for fuel pumped and exhaust offloaded.

28. A non-transitory machine-readable storage medium storing processor-executable instructions that, when executed by one or more processors, cause the one or more processors to:
determine proximity of a vehicle based on detection of one or more signals or physical characteristics of the vehicle;
in response to the vehicle being within a selected proximity of a fuel site, obtain data associated with the vehicle and a user associated with the vehicle from the one or more signals or physical characteristics;
determine a predicted amount of fuel to fill a fuel tank of the vehicle;
transmit the predicted amount of fuel to the user; and
in response to reception of a selected amount of fuel, initiate fuel pumping operations.

29. The non-transitory machine-readable storage medium of claim 28, further comprising instructions to, when executed by the one or more processors:
determine a predicted amount of exhaust to offload from an exhaust tank of the vehicle;
transmit the predicted amount of exhaust to the user; and
in response to reception of a selected amount of exhaust, initiate exhaust offloading operations.

30. The non-transitory machine-readable storage medium of claim 29, wherein the data associated with the vehicle includes a fuel tank level, a fuel tank capacity, an exhaust tank level, and an exhaust tank capacity.

31. The non-transitory machine-readable storage medium of claim 30, wherein the predicted amount of fuel to fill the fuel tank is based on the fuel tank level and the fuel tank capacity, and wherein the predicted amount of exhaust to offload from the exhaust tank is based on exhaust tank level and exhaust tank capacity.

32. The non-transitory machine-readable storage medium of claim 30, wherein the data associated with the vehicle comprises vehicle mileage, last fueling station visited, vehicle miles per gallon, and exhaust emitted per mile.

33. The non-transitory machine-readable storage medium of claim 32, wherein the predicted amount of fuel to fill the fuel tank is based on the fuel tank level, vehicle mileage, last fueling station visited, vehicle miles per gallon, or some combination thereof, and wherein the predicted amount of exhaust to offload from the exhaust tank is based on exhaust tank level, vehicle mileage, last fueling station visited, exhaust emitted per gallon, or some combination thereof.

34. The non-transitory machine-readable storage medium of claim 29, wherein the one or more signals or physical characteristics of the vehicle include one or more of a Wi-Fi signal, a RFID signal, a NFC signal, a cellular signal, a Bluetooth signal, vehicle identification number (VIN), a license plate, a radio-frequency identification (RFID) tag, a sensor, or other transmitter configured to securely send vehicle information.
